(19) United States
(12) Patent Application Publication
(10) Pub. No.: US 2014/0237076 A1
(43) Pub. Date: Aug. 21, 2014

(54) Content Management And Delivery of On Location Engagements

(71) Applicant: On Location Engagements, Inc., Orange, CA (US)

(72) Inventors: Iris Goldman, Orange, CA (US); Claudio Pracilio, Orange, CA (US); Darek Lowen Senkow, North Muskegon, MI (US)

(73) Assignee: On Location Engagements, Inc., Orange, CA (US)

(21) Appl. No.: 14/185,904

(22) Filed: Feb. 20, 2014

Related U.S. Application Data
(60) Provisional application No. 61/767,326, filed on Feb. 21, 2013.

(51) Int. Cl. H04W 8/24; H04L 29/08

(52) U.S. Cl. CPC H04W 8/24; H04L 67/18
USPC 709/217

(57) ABSTRACT

A system and method for content management and delivery of on location engagements is disclosed. Content is identified by the use of a beacon at each location of interest. The series of beacons are mapped on a beacon floor plan function where placement, signal strength, and exhibit or location coordinates can be optimized to provide the user with a favorable on location experience. The content is filtered by a manager component where a curator can define an experience that the user can choose from. Further, the identifier associated with each beacon also provides filtering of content so that the content is related to the location of the user. Optionally, a registration function provides additional filtering and the user can also filter the content to be delivered. The delivered content is received on a handheld electronic device where the user can choose an experience of interest, providing meaningful, and relevant information to the user.

### CROSS-REFERENCE TO RELATED PATENT APPLICATIONS

This application claims the benefit of the filing date of U.S. Provisional Patent Application No. 61/767,326 filed on Feb. 21, 2013.

### BACKGROUND OF THE INVENTION

1. Field of the Invention

This invention relates generally to content management and delivery systems, and more particularly to a computer based system and method for content management and delivery of on location engagements.

2. Description of Related Art

Physical environments such as museums, theme parks, trade shows, airports, universities, retail stores, and other venues constantly struggle to engage with guests, patrons or consumers in a way that creates a satisfying and meaningful experience. The visitor can become easily disengaged or bored with the physical environment he or she is experiencing. This disengagement is not good for the purveyor of the physical environment, as it means lower sales, lower repeat visits, poor word of mouth referrals, and the like. Historically, signs, placards, and more recently audio and visual effects have been used to enhance the visitor's experience. When a visitor comes upon a certain display, for example, they may press a button and hear a recorded audio clip, or a motion sensor may start the audio playback. Additionally, in some venues, small video screens have been installed to provide further information by way of video segments. These enhancements to the on location experience have been problematic at best. The playback of multiple audio clips throughout an open air space, for example, can be distracting or even annoying. In addition, some visitors do not wish to hear this audio, and find it bothersome. The use of video displays to enhance an exhibit is also problematic, especially if the venue is crowded and many people are competing to see the video screen that has been installed as part of the exhibit. These audio and video systems must be installed at a one to one ratio; one system for each exhibit. This tends to make the overall installation costly, and also makes updating the content at each system slow and cumbersome. Until recently, these playback systems lacked user interaction, and were a monologue of information that started and stopped at fixed times. With the advent of touch screen computer displays, some of these limitations were eliminated. The visitor could now touch the screen at the exhibit to start or stop the video, and could also select what information should be displayed. What is needed is a system and method that allows a visitor to interact with an exhibit to obtain desired content. What is also needed is a system and method that is unique to each visitor, and can be customized to each visitor. What is also needed is a system and method where content can be changed to conform to the needs of the visitor. What is also needed is a system and method where content can be delivered direct to the visitor's electronic device.

To take these systems to the next level the present invention provides a digital augmentation to physical spaces, where each guest enters a venue with their mobile device and a micro location interaction occurs to serve relevant content, personalized content, and way finding mapping. The present invention provides personalized content that is clutter free, direct, and wanted by venue guests.

It is therefore an object of the present invention to provide a system and method for content management and delivery of on location engagements. It is another object of the present invention to provide a system and method for content management and filtering of content for on location engagements. It is another object of the present invention to provide a system and method to manage on location engagements.

These and other objects of the present invention will become evident to one skilled in the art after a review of this specification, claims, and the attached drawings.

### BRIEF SUMMARY OF THE INVENTION

In accordance with the present invention, there is provided a system for content management and delivery of on location engagements comprising a computer having a processor, memory; arid access to computer readable media; a computer program stored on computer readable media having an OLE manager where the OLE manager comprises a beacon assignment/reassignment function, a beacon signal strength measurement function, a beacon signal strength adjustment function, and a content management function; content stored on computer readable media for selective activation by the OLE manager; at least one wireless beacon for location based delivery of an associated beacon identifier; a means to correlate the beacon identifier with selected content; and a consumer app resident on a wireless communications device that is capable of receiving and displaying the selected content.

The foregoing paragraph has been provided by way of introduction, and is not intended to limit the scope of this invention as defined by this specification, claims, and the attached drawings.

### BRIEF DESCRIPTION OF THE DRAWINGS

The invention will be described by reference to the following drawings, in which like numerals refer to like elements, and in which:

FIG. 1 is a diagram depicting the system for content management and delivery of on location engagements;

FIG. 2 is a block diagram of the content management system of the present invention;

FIG. 3 is another block diagram of the content management system of the present invention;

FIG. 4 is a flowchart depicting a method of beacon selection;

FIG. 5 is a diagram depicting content filtering;

FIG. 6 is a beacon floor plan layout function of the present invention;

FIGS. 7 and 8 are exemplary screenshots depicting filtering of content;

FIGS. 9 and 10 are exemplary screenshots depicting page level filtering;

FIGS. 11-28 are various exemplary screenshots of the present invention; and

FIGS. 29-31 are exemplary handheld electronic device screenshots of the OLE app.

The present invention will be described in connection with a preferred embodiment; however, it will be understood that there is no intent to limit the invention to the embodiment described. On the contrary, the intent is to cover all alternatives, modifications, and equivalents as may be included within the spirit and scope of the invention as defined by this specification, claims, and the attached drawings.

### DESCRIPTION OF THE PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

For a general understanding of the present invention, reference is made to the drawings. In the drawings, like reference numerals have been used throughout to designate identical elements.

An architectural overview of the present invention is first presented.

Physical environments are struggling to engage with consumers or guests in a meaningful, targeted and interactive way. With a single or many relevant points of contact (beacons) we can create an engagement, call to action interaction, branded experience or a deeper guest exploration. This can be done by utilizing a smart phone (User) with the OLE consumer app, an application (OLE Manager) and a wireless beacon (Beacon) technology. The present invention can be used in such a way as to provide a customized, personalized, and unique experience with every visit in any venue. These venues can be Museums, Theme Parks, Trade Shows, Conferences, Hospitals, Retail Environments and the like.

The present invention, referred to herein as the On Location Engagements system, or simply the OLE system, creates user experience by engaging guests in an environment outfitted with strategic placement of wireless Beacons. These wireless beacons, in combination with a method of beacon selection, provide information to an application (app) running on a user's handheld device to indicate which beacon the user is closest to, thus allowing selection of content appropriate to that user's location. Technologies such as Bluetooth Low Energy (also known as Bluetooth Smart or Bluetooth 4.0) Classic Bluetooth, WiFi, ZigBee, or even custom Radio Frequency technologies or audio signals may be used as wireless beacons in the present invention. With the use of handheld mobile devices such as smartphones, tablet computers, and the like, it is now possible to use an individual's personal, mobile device to discover an immersive experience.

The OLE architecture is designed around the following participants: Users, Content Creator, Beacon Registration and Installers. Each participant has a distinctive role and purpose.

The User is the individual that is consuming OLE content with the OLE consumer app. The user is equipped with a mobile device that incorporates a wireless technology. A native application runs on the mobile device, allowing the user to trigger an experience by being in the presence of an OLE beacon. The experience can be used at the start of a queue to a theme park ride, a booth location in a trade show hall, or an object in a retail store.

The job of the Content Creator is to assign content to items of interest that are location relevant. Content can easily he updated with the OLE Manager to maximize a visitor's experience and information relevance to a particular place and time. The job of the Content Creator is to continually create new engagements for their users. Examples of such content creation include a Treasure Hunt exploration at a museum, information about an object at a retail store, or a warning that a certain area of a structure is closed.

The OLE Manager is a native application that is designed to be used by the Content Creator. An example of a content creator is a museum curator. The purpose of the OLE Manager is to define the content that the OLE Consumer App will show to the User.

The OLE Content Management System contains cloud or network based storage facilities for the OLE Manager, and provides the OLE consumer app with published content.

Beacon Registration is the process of recording beacon signal identification in the OLE Content Management System using the OLE Discovery App. Each beacon is assigned to a specific client with settings that define the range of signal strength that the OLE consumer app will detect. This method of beacon selection is further defined herein.

The Installer's job is to install and maintain the beacon on location and in the OLE Manager. While in the field, the installer verifies and validates content assignment per beacon. Installers have the ability to calibrate beacons and assign range definition per venue configuration. An installer may have an association with multiple beacons per item of interest per item physical scale. In some embodiments of the present invention, beacon signal strength may be reduced or increased depending on the location of the beacon in the geographical space.

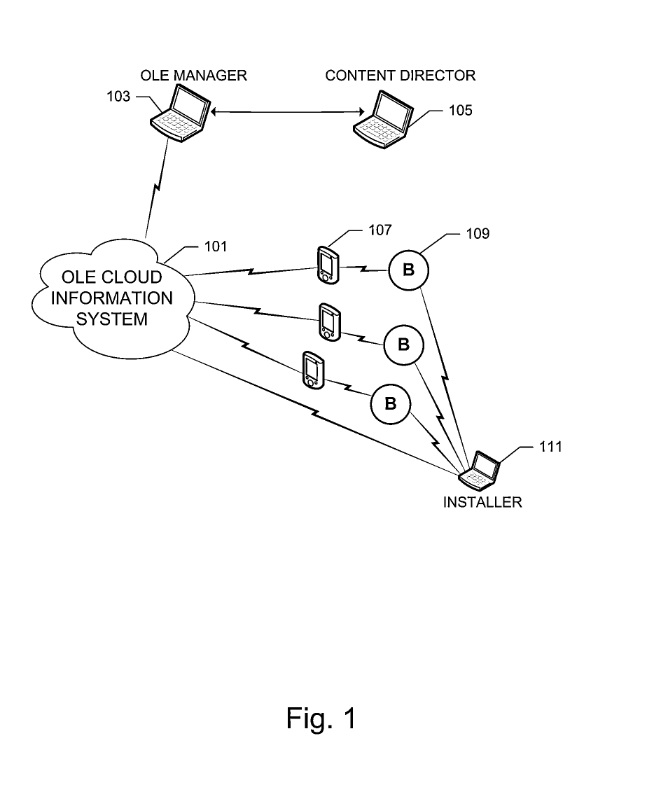

Turning now to FIG. 1, a diagram depicting the system for content management and delivery of on location engagements is shown. As described above, the general architecture of the OLE system includes an OLE cloud information system 101 which is a network or networks that distribute and provide information content to handheld electronic devices containing the OLE consumer app 107 by way of a wireless network. The OLE consumer app senses the proximity of beacons 109 that may include technologies such as Bluetooth Low Energy (also known as Bluetooth Smart or Bluetooth 4.0) Classic Bluetooth, WiFi, ZigBee, or even custom Radio Frequency technologies or audio signals may be used as wireless beacons in the present invention. The installer 111 provides a computer based platform to set up and manage the wireless beacon or beacons. The OLE manager 103 is the computer based platform upon which user content is created, edited, and maintained. A content director 105 is connected to the OLE manager 103 by way of a wired or wireless network and provides an environment to work with the OLE manager 103.

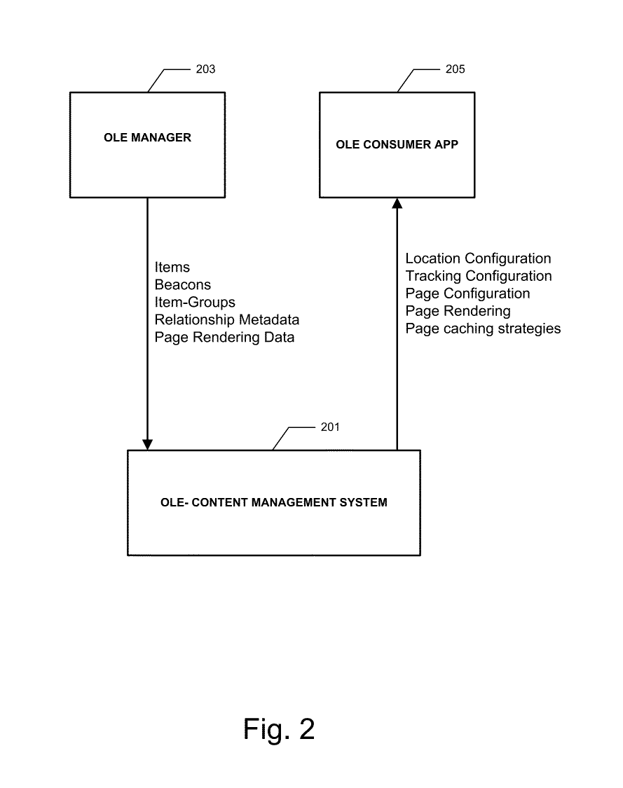

FIG. 2 is a block diagram of the content management system of the present invention. The OLE content management system 201 can be seen operatively connected to the OLE manager 203 and the OLE consumer app 205 that resides on a user's electronic device. The OLE manager 203 works in conjunction with the OLE content management system 201 to control the overall structuring, management, delivery and filtering of content to the OLE consumer app 205. The OLE manager 203 provides tools for the management of items, beacons, relationship metadata, page rendering data, and the like. The OLE consumer app 205 in turn allows for the selection of appropriate content through processes such as geographic location through beacon selection, user registration, and user selections. The OLE consumer app manages location configuration, tracking configuration, page configuration, page rendering, and page caching strategies.

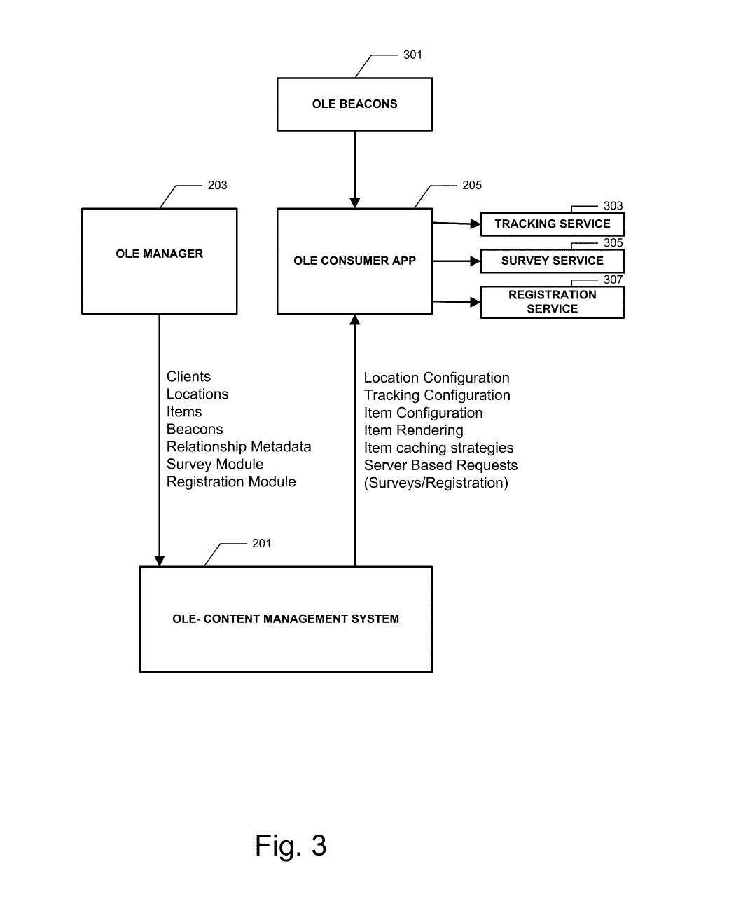

FIG. 3 is another block diagram of the content management system of the present invention again depicting the OLE content management system 201 with the OLE manager 203 and the OLE consumer app 205. The OLE manager 203 manages clients, locations, items, beacons, relationship metadata, the survey module, and the registration module. The OLE consumer app 205 receives information from the OLE content management system 201 that includes location information, tracking configurations, item configurations, item renderings, item caching strategies, server based requests, surveys, registration information, and the like. The OLE consumer app 205 connects with the tracking service 303, the survey service 305, and the registration service 307.

The tracking service 303 allows for the recording of on-location content delivery for the engagement zone. Whenever a change of engagement or contact zone is encountered, the OLE Consumer app delivers content relevant to the user/consumer and also records the on-location consumption of content.

The survey service 305 allows the curator or manager to define relevant questions for the user in order to provide feedback on the engagements, and thus allows the curator or manager to refine the engagement for subsequent users. The OLE Consumer app provides the interface for the user to answer the survey and provide feedback back to the curator or manager.

The registration service 307 enables the OLE Client to define attributes such as user classification, enabling the curator or manager to provide both Item level and Page level filtering capabilities based on such attributes. An example use-case includes the OLE Consumer app requesting a registration code from the user, which in-turn performs a look-up to determine the user-classification. Once the registration metadata is determined, rules based on registration data can be used to drive different content to the end user.

The present invention is a system for content management and delivery of on location engagements comprising a computer having a processor, memory, and access to computer readable media; a computer program stored on computer readable media having an OLE manager where the OLE manager comprises a beacon assignment/reassignment function, a beacon signal strength measurement function, a beacon signal strength adjustment function, and a content management function; content stored on computer readable media for selective activation by the OLE manager; at least one wireless beacon for location based delivery of an associated beacon identifier; a means to correlate the beacon identifier with selected content; and a consumer app resident on a wireless communications device that is capable of receiving and displaying the selected content.

In some embodiments of the present invention, the content management function allows for the selection and filtering of location based content, user selected content, registration content, and owner based content.

In some embodiments of the present invention, the OLE manager further comprises a user interface.

In some embodiments of the present invention, the OLE manager further comprises a user information component stored on computer readable media.

In some embodiments of the present invention, the user information component further comprises user input requests received on a computer.
In some embodiments of the present invention, the user information component further comprises metadata from user registration data sources stored on computer readable media.
In some embodiments of the present invention, the user information component further comprises historical user usage data stored on computer readable media.
In some embodiments of the present invention, the system further comprises an analytics module stored on computer readable media.

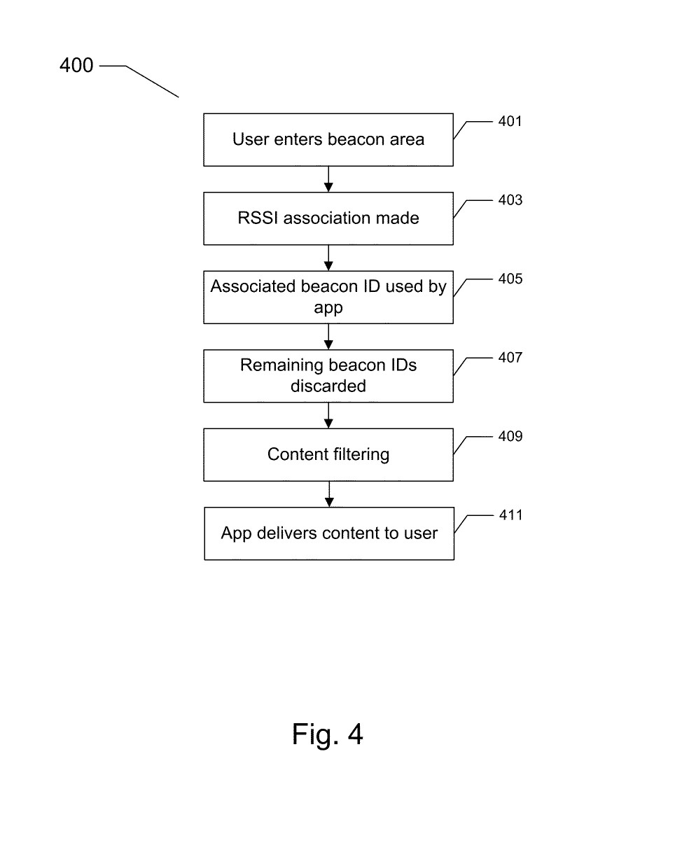

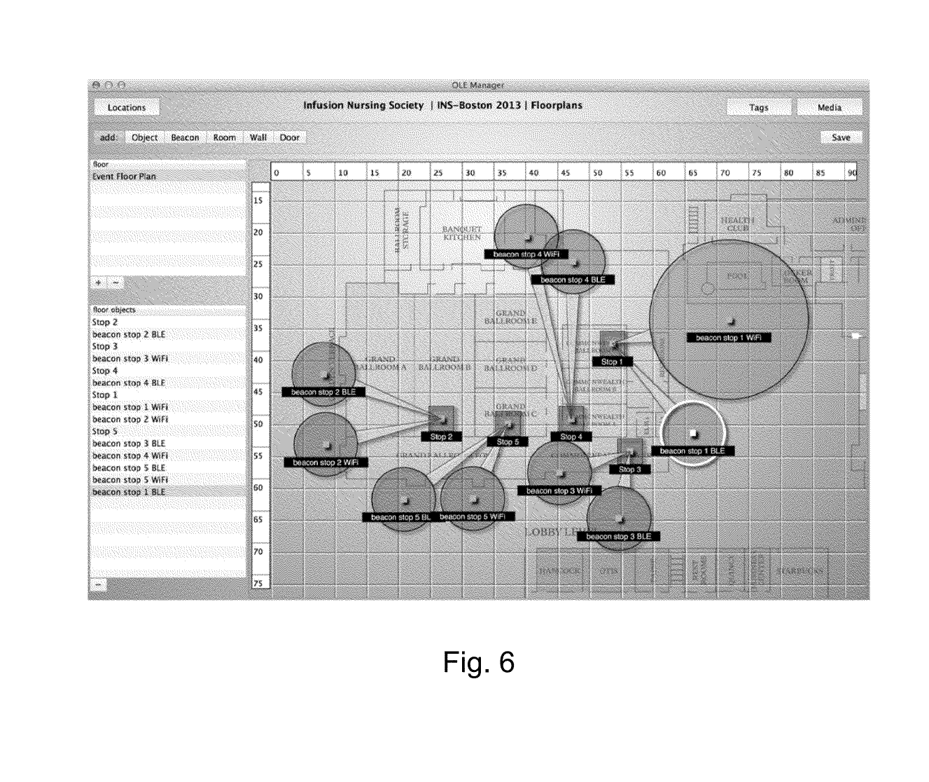

FIG. 4 is a flowchart depicting a method of beacon selection. As a user enters a location that may have multiple beacons installed in step 401, the user's handheld device receives signals from the multiple beacons. Each received beacon signal has a Received Signal Strength Indication (RSSI) that is a numeric value generated by the handheld device based on the signal strength measured from each beacon to the handheld device. Using the method of the present invention, a single beacon is selected and an RSSI association is made in step 403. This RSSI association tells the OLE consumer app which set of content to select and use. In step 405, this associated beacon Identifier, typically an alphanumeric series of characters, is used by the OLE consumer app that is resident on the user's handheld device to determine appropriate content to be sent. In step 407, the remaining beacon identifiers are discarded, and in step 409 the app on the user's handheld device delivers content associated with the associated beacon. This method of beacon selection ensures that the user receives content that they were intended to receive based on their geographical location. In locations where there is a high density of beacons, the placement and signal strength of the beacons, as managed by the present invention through targeted connection configurations such as depicted graphically by way of FIG. 6, is of paramount importance. Once proper placement and signal strength of the beacons is achieved, the method of beacon selection as described herein helps to ensure that only the content that is intended to be received by the user is actually received by the user.

In one embodiment of the present invention, a method for content management and filtering of content for on location engagements comprises the steps of establishing on a computer content to be delivered to a location, detecting with a radiofrequency receiver a radiofrequency signal containing a beacon identifier, measuring signal strength of the received radiofrequency signal, comparing the measured signal strength of the received radiofrequency signal with measured signal strength of other received radio frequency signals.

determining the location of a user based on the beacon identifier and the measured signal strength of the received radiofrequency signal, selecting on a computer content based on a user's location, modifying on a computer content to be delivered, and filtering the modified content by user selection criteria on a wireless communications device. In some embodiments of the present invention, the method further includes the steps of receiving on a computer user registration information, and filtering the selected content based on user registration information.

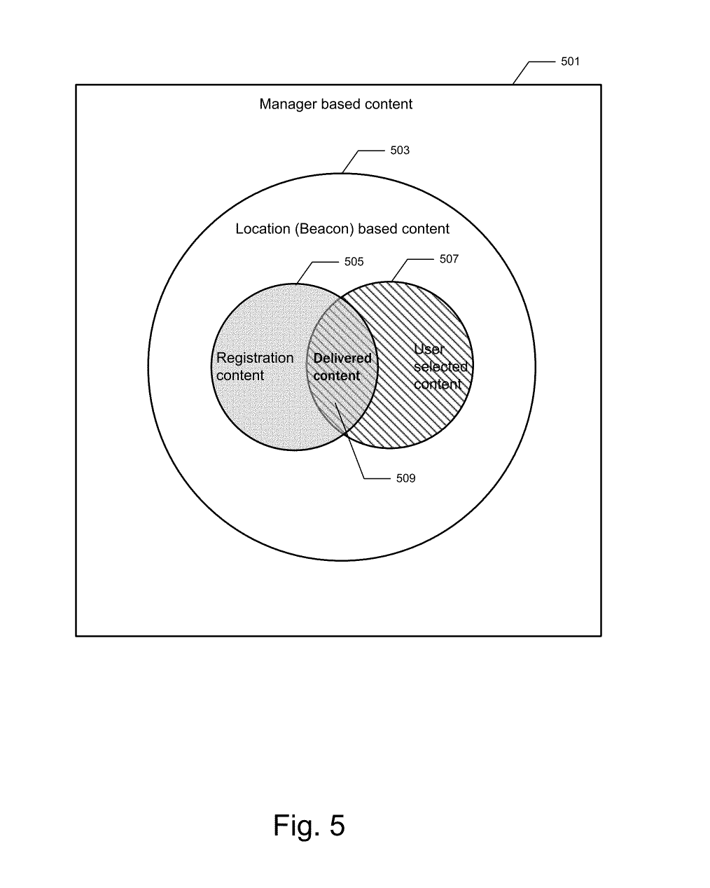

Content is filtered and delivered to a user in several ways. First, content is filtered through geographic or proximity information based on the method of beacon selection described above based on manager based content 501 that is selected by a manager of the given venue. Once only the relevant content is sent to the user based on location information determined by the method of beacon selection using RSSI information as depicted in FIG. 5 where location (beacon) based content 503 is delivered to a user, optionally a user is prompted to register. Registration may be by way of a simple login or more detailed questions about the user. In some embodiments of the present invention, registration information received from the user is supplemented with additional user information from other sources such as a database of members, users, or the like. Based on the registration information received, additional, filtered, or supplemental content is then delivered to the user as registration content 505. In addition, in some embodiments of the present invention, the user is given the option to select content that is most meaningful or of interest. This user selected content 507 may be selected by way of menu choices, drop down windows, icons, or other techniques that are used in conjunction with a graphical user interface. Delivered content 509 is then a subset of the manager based content, location based content, the registration content and the user selected content. The delivered content is unique to that user, thus providing a customized and tailored on location experience.

FIG. 6 is a screenshot depicting a beacon floor plan layout function that provides an operator of the system with a graphical representation of the floor plan of the venue with beacon placement, assignment, and signal strength depicted. The beacon floor plan layout function is stored on computer readable media and graphically displayed on a computer monitor comprising a graphically displayed floor plan of a venue, a map of radio-frequency beacons overlaid on the graphically displayed floor plan, and a circle circumscribing each mapped radiofrequency beacon where the diameter of each circumscribed circle corresponds to the signal strength of the radiofrequency beacon that the circle circumscribes. Each circumscribed circle represents a content zone where specified content can be delivered to a user through the OLE consumer app on the user's handheld electronic device. Further, the signal strength and the related circumscribed circle are used to determine location of a user. The graphically displayed floor plan of the venue may include rooms, exhibits, levels, and the like. The map of radiofrequency beacons may comprise one or more beacons with a visual indicator of signal strength being the diameter of the circumscribed circle. The beacon floor plan layout function may depict more than one beacon being assigned to an area, exhibit, or the like. The beacon floor plan layout function may also, in some embodiments of the present invention, comprise a map of floor stops overlaid on the graphically displayed floor plan indicative of the general location at which a visitor would stop to view a display. Floor stops may be a physical structure such as a window of an exhibit or they may represent a typical location at which a visitor would stop to view an exhibit, display, or the like.

The beacon floor plan layout function may also, in some embodiments of the present invention, comprise callouts from each circumscribed circle to the floor stop associated with the circumscribed circle. The callouts may, for example, be arrows, lines, vectors, or the like.

In some embodiments of the present invention, the floor stop is associated with more than one beacon and more than one circumscribed circle.

The beacon floor plan layout function may also, in some embodiments of the present invention, comprise floor objects comprising radiofrequency beacons and floor stops.

The beacon floor plan layout function may also, in some embodiments of the present invention, comprise a measurement grid overlaid on the graphically displayed floor plan. The measurement grid may indicate meters, feet, or other measurement unit.

The beacon floor plan layout function may also, in some embodiments of the present invention, comprise a color associated with each circumscribed circle where the color is indicative of the status of each mapped radiofrequency beacon. For example, the color green may be indicative of an active radiofrequency beacon and the color red is indicative of an inactive radiofrequency beacon. In some embodiments of the present invention, a mapped radiofrequency beacon without a circumscribed circle is indicative of a radiofrequency beacon that is not in operation.

According to some embodiments of the present invention, when a user is within proximity of a beacon, that association triggers relevant content to the user utilizing a portable viewing device.

According to some embodiments of the present invention, the relationship between user and beacon is connectionless wireless identification.

According to some embodiments of the present invention, when using strategic placement of beacons and relevant dynamic content, a “tour” experience can be designed by the content creator and director. With the OLE Manager the content creator can categorize items to create “tours”. A “lour” is a collection of beaconed items. A user can experience the same tour with different content based on rules driven by user registration and preferences.

According to some embodiments of the present invention, venue maps are automatically generated on the OLE smartphone app, providing the user with location specific maps.

According to some embodiments of the present invention, while on a selected “tour”, maps are automatically generated and only beacons that are included in the tour will trigger the OLE smartphone app to serve tour content.

According to some embodiments of the present invention, a user's content consumption pattern can trigger additional actions such as incentives, invitation to a VIP event or notifications to a venue or event owner.

According to some embodiments of the present invention, traffic density can be viewed in real time.

According to some embodiments of the present invention, beacons can be reassigned to items or content and be made instantly available to users.

According to some embodiments of the present invention, content can be configured to change base on a time schedule (for example, lunch special at 11:30 a.m., dinner special at 6 p.m.).

According to some embodiments of the present invention, notifications are broadcast to on location venue users (such as store closing in 15 mm.)

According to some embodiments of the present invention, location based chat is derived from proximity to OLE beacons.

According to some embodiments of the present invention, a connection is made with a venue representative (virtual information desk) by beacon proximity.

According to some embodiments of the present invention, content can be updated by a content creator and instantly available to users.

According to some embodiments of the present invention, additional beacon configurations can be used to support direction radial performance. Segmented antenna designs provide variable dispersion of the radio signal.

According to some embodiments of the present invention, it is possible to activate portions of the OLE beacons at a specific, targeted location and therefore create a user specific (age, gender, interests, history) experience similar to a “treasure hunt” or “hide and seek”.

According to some embodiments of the present invention, a variety of technologies, including real-time signal strength, time of flight, triangulation, GPS, trilateration, and special filtering allows the mobile device to get a more accurate location fix.

According to some embodiments of the present invention, a beacon installer app commissions beacons so that the OLE Manager sees each beacon in order to associate an object of interest and related content with each beacon.

According to some embodiments of the present invention, beacons do not have a single, specific meaning or “call to action” assignment during their lifetime. The beacons may be re-commissioned by using a cloud-based server to coordinate all significance and to create an experience.

According to some embodiments of the present invention, OLE allows the management of traffic flow at an event or experience, and is able to assess the popularity of attractions, and how well a new environment is interacting with consumers. Strategic beacon locations can manage their user's spatial behavior and redirect traffic in desired directions at specific times.

According to some embodiments of the present invention, a user's experience is customized based on repeat visits. The OLE content management system and native app know that a user has engaged in a particular experience and can create new engagements based on their likes, dislikes, and patterns.

According to some embodiments of the present invention, the range on an OLE beacon can be adjusted in the OLE Manager by the content creator to optimize the user experience. These adjustments are instantly available to users.

According to some embodiments of the present invention, the content creator has the ability to drag and drop content files to an item in the OLE Manager and will instantly be available to users.

According to some embodiments of the present invention, the OLE Manager is a visual “design your experience” platform uniquely merging beacon technology to a physical space, thus enabling the content creator to curate with visual digital tools.

The following are examples of industries, markets and venues that OLE has the potential to create new ways to connect to its guests. Some venues that install OLE will create simple single transactions, and some will create a more complex storied delivery.

a. Theme Parks

b. Trade-shows

c. Conferences

d. Hospitals

e. Airports

f. Universities

g. Libraries

h. Parking Structures

i. Concerts

j. Security

k. Hospitality

l. Real Estate

m. Travel

n. Cruises

o. Museums

p. Retail Stores

q. Manufacturing

r. Education

### EXAMPLE 1—RETAIL MARKET

An “OLE powered” sticker at the entrance of a retail store will remind guests to download or activate the OLE app. Within the store, a shopper will enter beacon zones in which a simple promotion or coupon is discovered on a smart phone. This interaction is a simple model, but with proper content and smart beacon placements, a shopper is introduced to new products and product details that may influence an immediate purchase or future shopping decisions. A shopper may be led to other similar products or given “behind the scene” product information, information and offers are easily update-able utilizing OLE Manager and instantaneously viewable by users. The OLE system allows guests to use the chat feature to connect and socialize with others within the beaconed venue. These types of discoveries reward the retailer with customer retention, customer loyalty, and learning (a positive way to connect and guide the consumer to make the right shopping choices).

### EXAMPLE 2—REAL ESTATE MARKET

A beacon will be placed at the “for sale” sign. The potential buyer will connect with information by simply turning on the OLE app. MLS listing information (as assigned by the listing agent for example;) is now available and optimized for smart phones. The potential buyer can see the interior details, listen to a narrative or see local comparable listings in the area with mapping features and direct listing agent contacts. OLE allows potential buyers to see “what's inside” and to determine if the house is worth looking at, what other homes are available around the area, price point, school rating, crime statistics, realtor information, and the like. Once the prospective buyer is inside the house, a beacon can relay relevant information, highlighting each house feature or upgrade unique to that structure. OLE allows interested parties to get relevant information on the spot and directly to their smart phone.

### EXAMPLE 3—MUSEUMS

A museum visitor will have a choice to rent or use personal smart phone. A visitor will have a choice of experience based on available tours or custom tours (the smart database will be able to create custom tours based on style, time period, artist and more). An adult can choose a “listening” tour only or a custom visual tour of a favorite artist. The tour will direct visitors via built-in maps (a beacon provides a mapping tool that is relevant to the guest's location) and will guide them to beaconed “spots”. Once in the “spot”, a connection is made and the desired information or interaction appears. A younger visitor will select a class tour designed specifically for that age group (by a teacher or curator for example), to be guided through the museum to discover and learn. The child is now able to use traditional tools, listen via headsets or answer and discover details by the beacon to beacon experience model. At each beacon zone, another piece of the puzzle is solved making it fun and engaging for both young and older visitors. This model is especially powerful when a guest learns something new without knowing they are learning. Also, OLE creates new and fresh engagements with an easy to update content database for repeat visits that are based on guest history or preferences, making every visit a new learning experience, thus making static environments come to life.

### EXAMPLE 4—TRADE SHOW

OLE is visual and able to cater to many exhibitors at a specific show. The OLE Manager is able to upload the overall show floor plan or just an exhibitor floor plan, OLE is able to cater to one or many exhibitors or enable the whole show for an association. The OLE beacons are portable allowing for on the spot changes to product placement. Also, item content is easily updateable, allowing the exhibit manager extreme flexibility in managing their on location exhibit experience. OLE Manager has modules to enhance attendee experience such as a Log-in Module to sign in advance with the ability to “build your own show” experience which will identify booths with relevant products or just to map the attendee visit to specific booths.

The OLE Chat feature is especially important as chat groups with various interests can be created to collaborate and interact while at the trade show. Once at a beaconed booth, an attendee can be identified by the OLE Sign-in module and given proper credentials such as buyer, reseller, consumer, media etc. by viewing certain products, and can be given related messages or an invitation to a private event or told that a face to face meeting is being arranged. With OLE, a portable solution that requires little set up and management, the engagement potential is endless. For customers, attendee beaconed visits are measured and items of interest can be tracked for follow up marketing.

### EXAMPLE 5—RESTAURANT

A diner in an OLE enabled restaurant will be prompted to download the app by way of venue signs, venue advertisement or by venue staff. Once the app is downloaded, diners will start receiving information based on their location (entrance, bar or dining room etc.). Information will be relevant to the diner's location within the restaurant (location based facts at the entrance, bar facts and menu at the bar area, dining facts and menu at the dining area). The diner receives a timed information stream that engages the user and highlights the specific venue. Coupon and incentive offers are managed by a content team at each venue. A timed coupon or incentive can drive more customers to the dining room or to the bar area to increase sales and achieve customer loyalty. A chat feature can be activated within the beaconed area for socializing and engagement with others. OLE is able to direct dining habits with incentives to make the dining experience a measurable event for OLE customers.

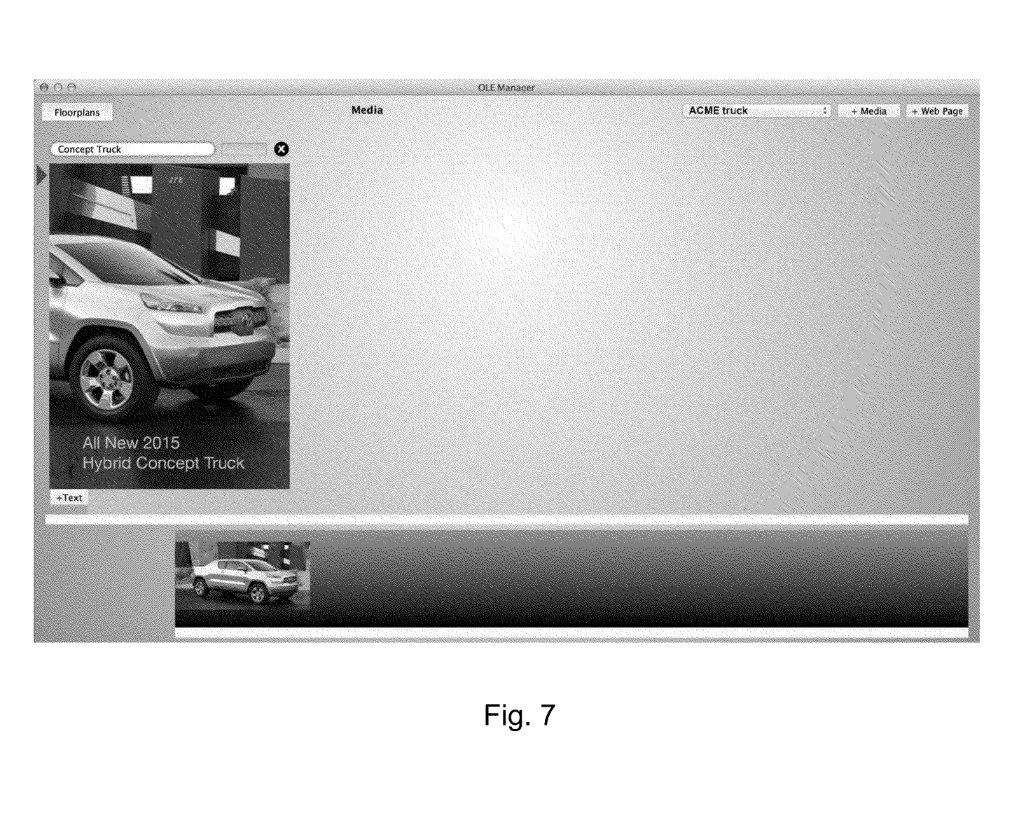

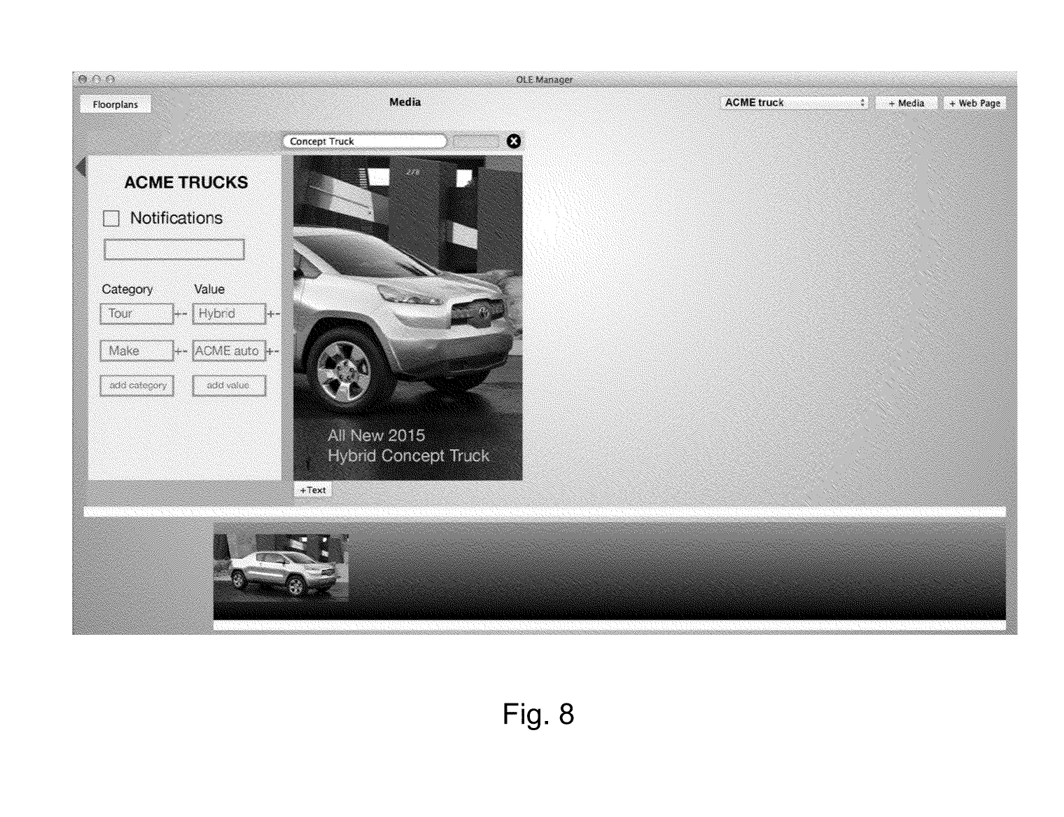

To further describe the filtering of content of the present invention. FIGS. 7 and 8 are exemplary screenshots depicting filtering of content at the OLE manager 103 (see FIG. 1). In FIG. 7, the type of media is depicted, in this example, concept trucks. Moving to FIG. 8, a manager or curator, for example, is provided with further selections regarding the categories that are defined under the grouping concept truck. In the Example of FIG. 8, the tour is defined as a tour of hybrids, and the make selected is ACME auto.

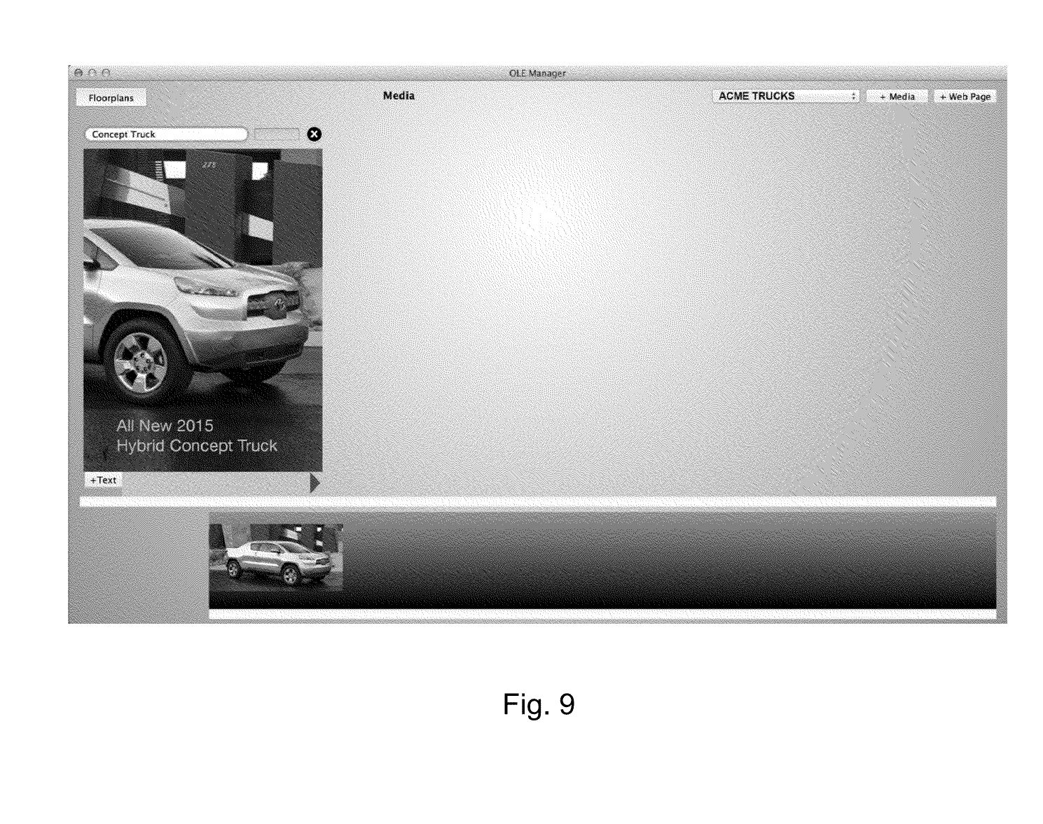

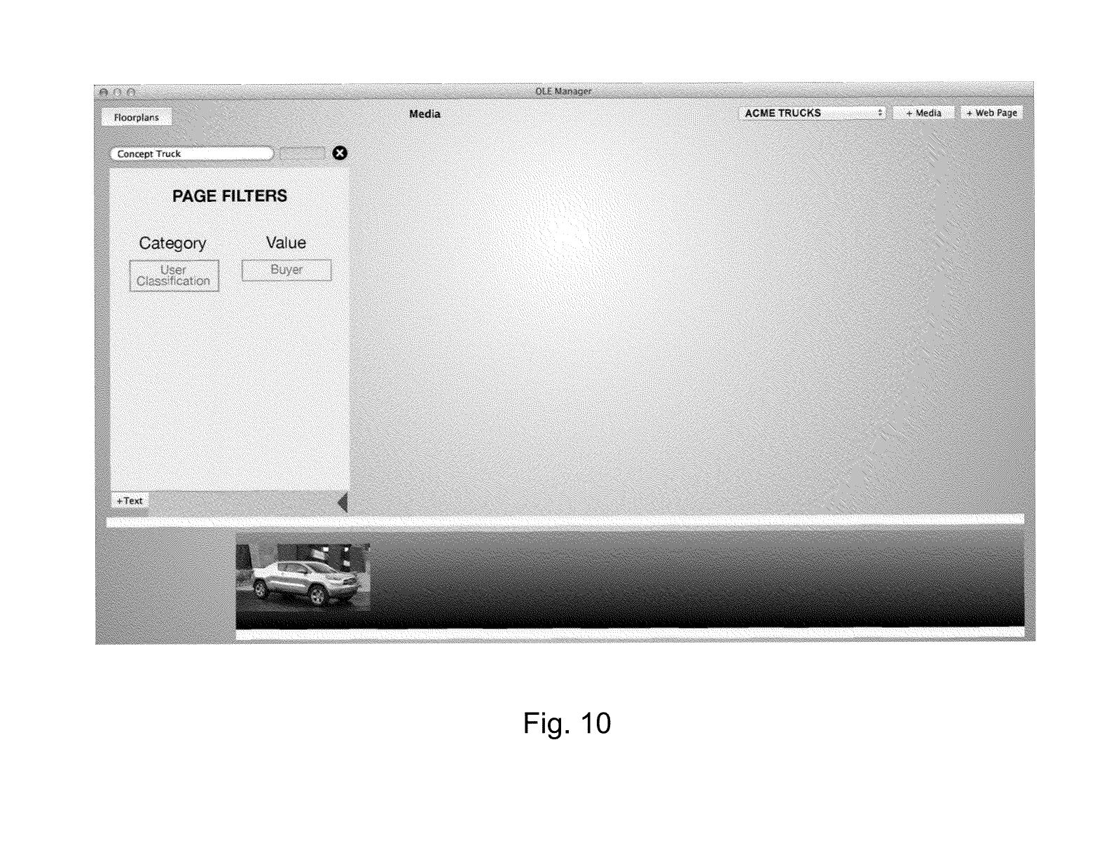

FIGS. 9 and 10 are exemplary screenshots depicting page level filtering where again the type of media is depicted in FIG. 9, in this example, concept trucks. In FIG. 10, page filters are depleted where in this example the user classification is selected as buyer. In this example, content may vary depending on the type of user selected. A buyer may receive different information than a consumer or a dealer, for example. In this way, the filtering methods and techniques of the present invention provide a custom, relevant and meaningful experience that was heretofore not attainable.

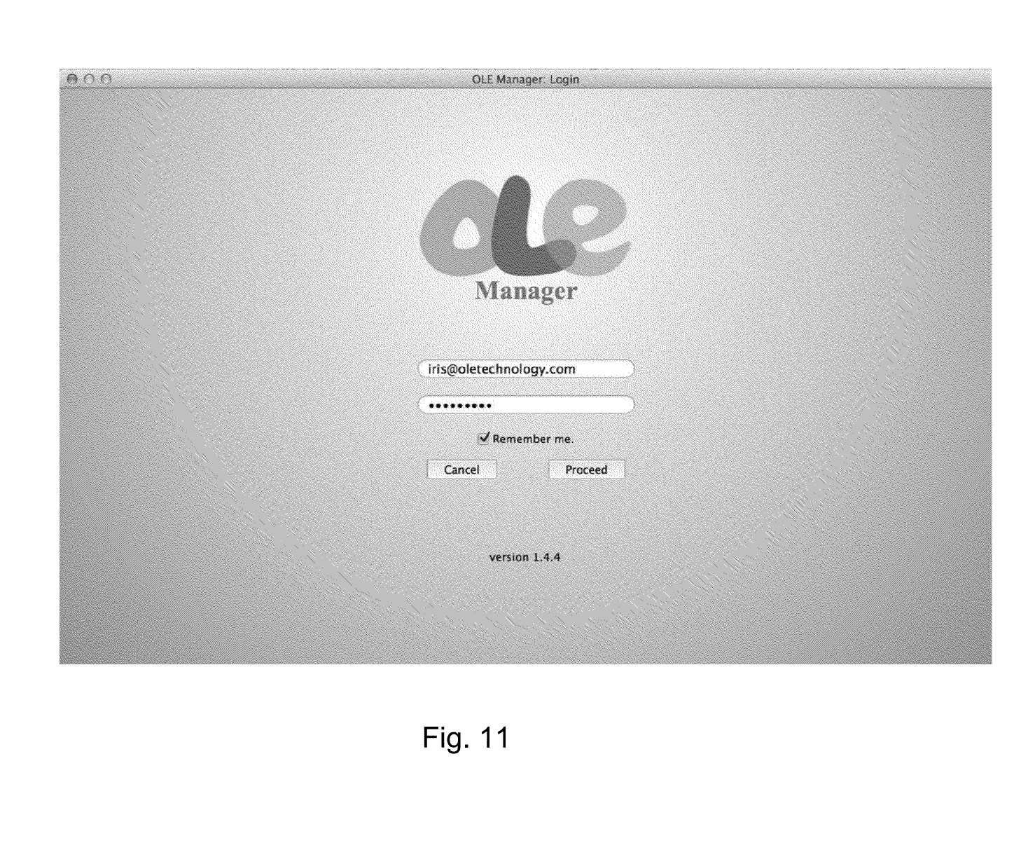

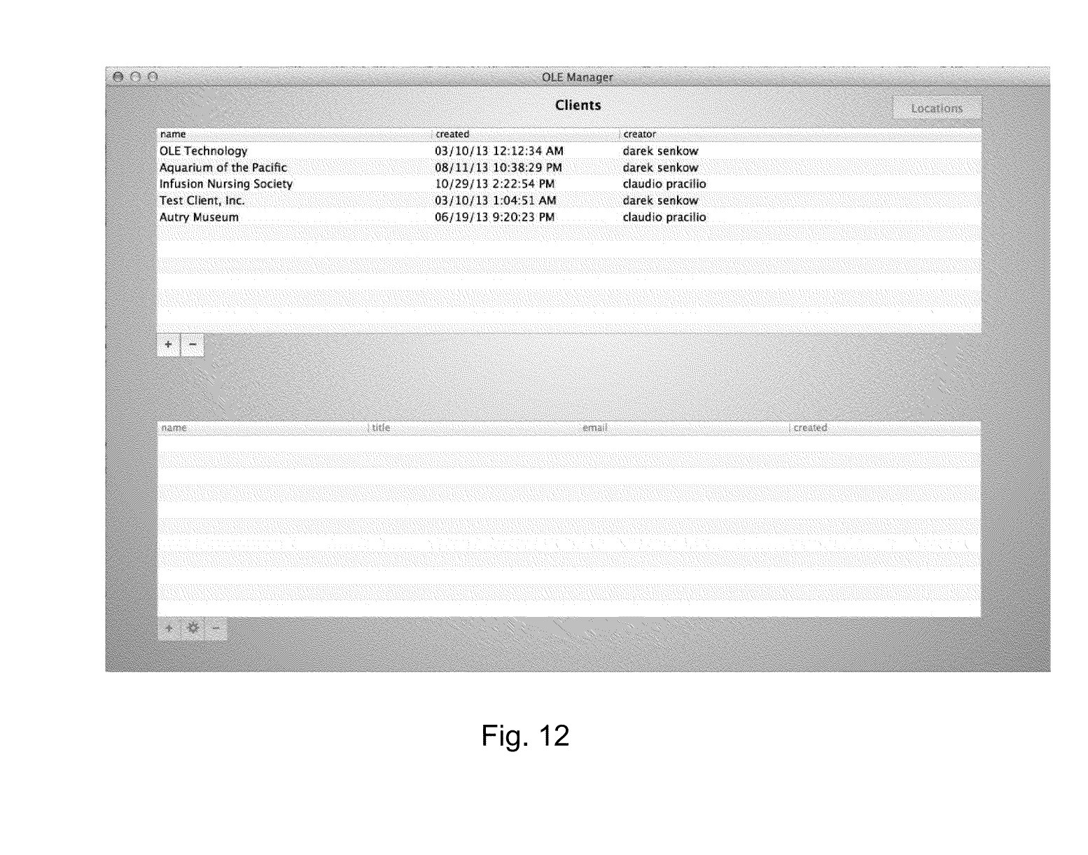

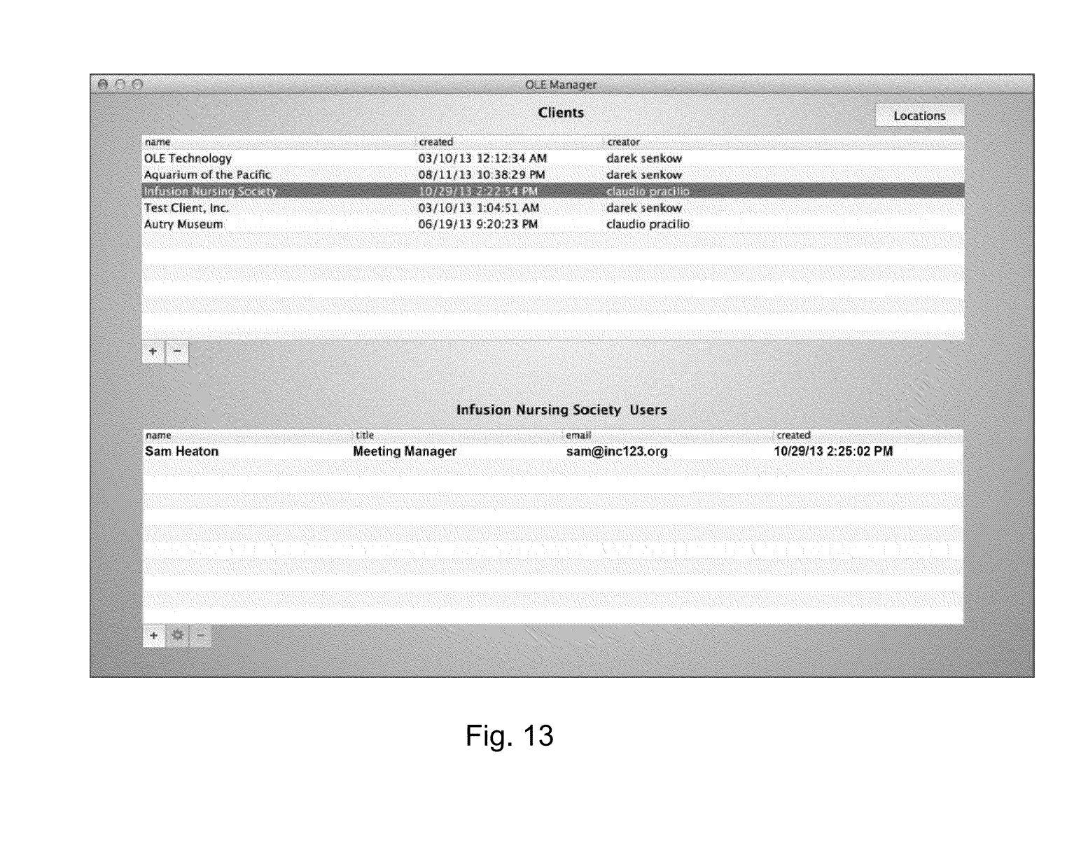

To fully describe the present invention and the various embodiments depicted and envisioned herein. FIGS. 11-28 depict various exemplary screenshots of the present invention. FIG. 11 simply depicts a login screen of the OLE Manager, as illustrated and described by way of FIGS. 1, 2 and 3. In some embodiments of the present invention, the OLE manager may support multiple clients, as depicted in FIG. 12 where a listing of clients is depicted, each of which may be selected through appropriate highlighting and/or line selection by way of a human interface such as a mouse, a touch screen, or the like. Once a client is selected, a listing of users for that client is displayed below the clients window, as exemplified by way of FIG. 13.

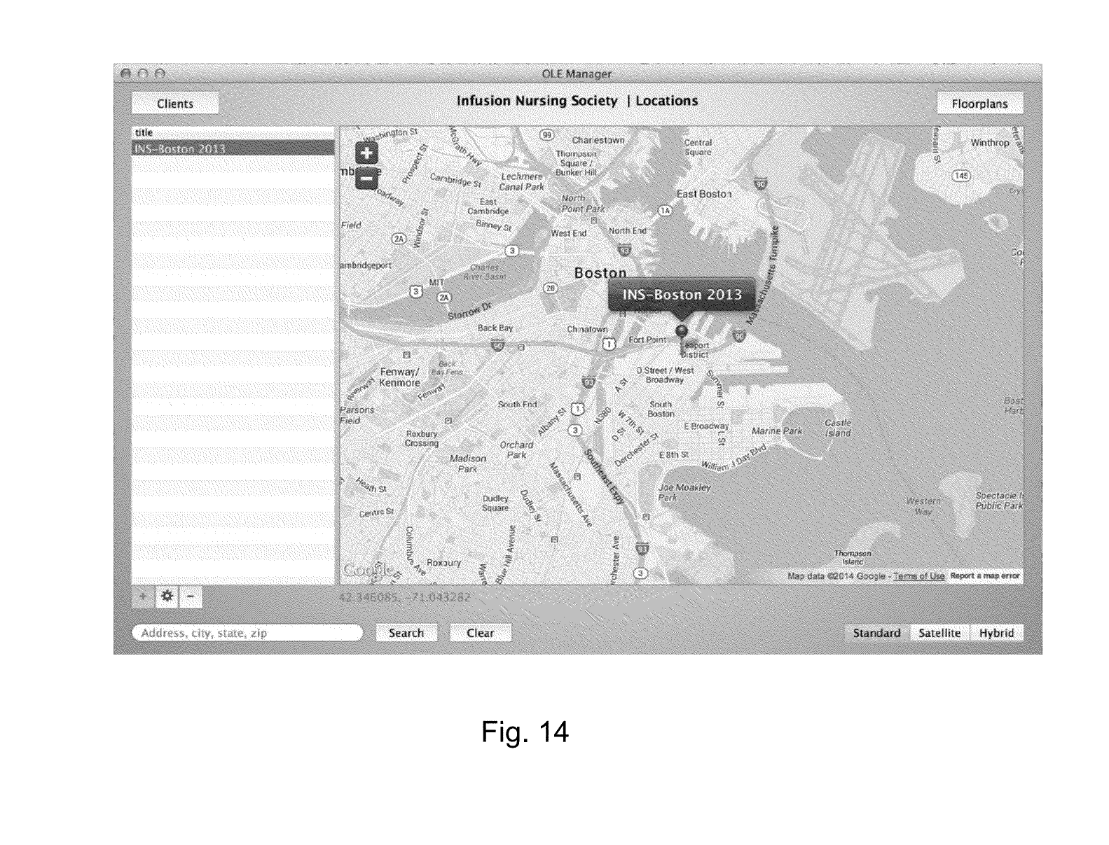

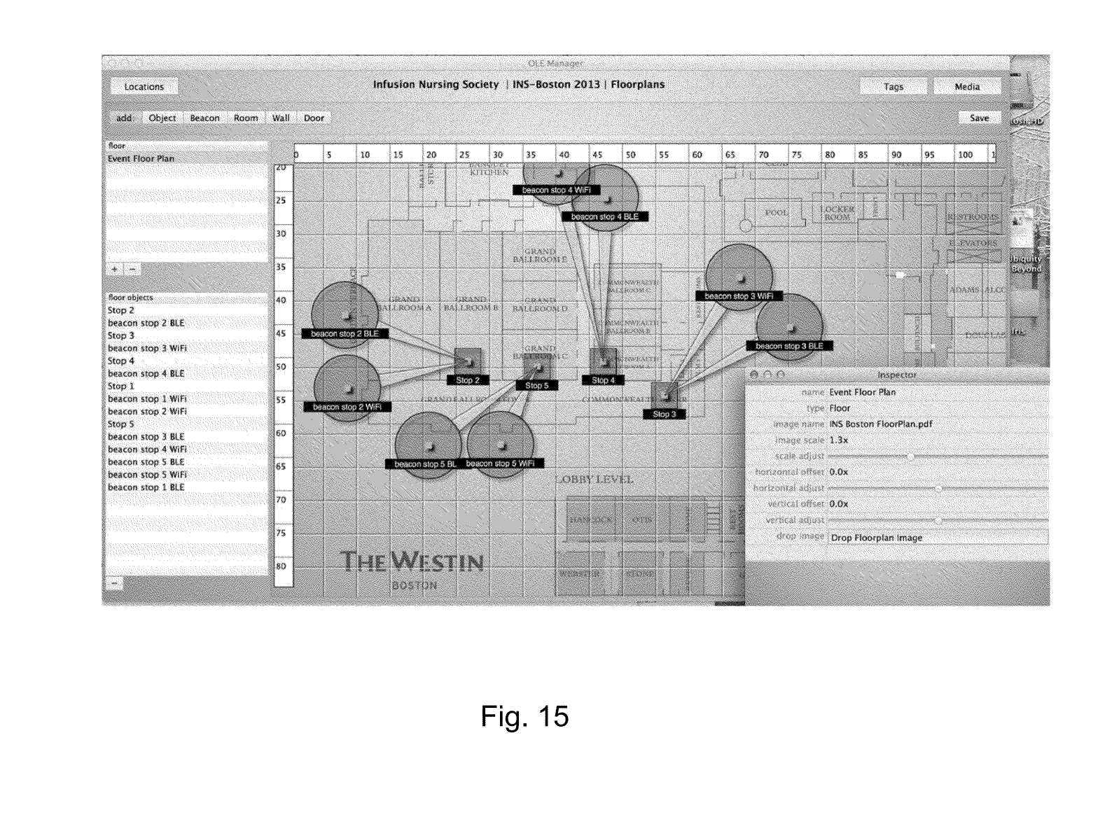

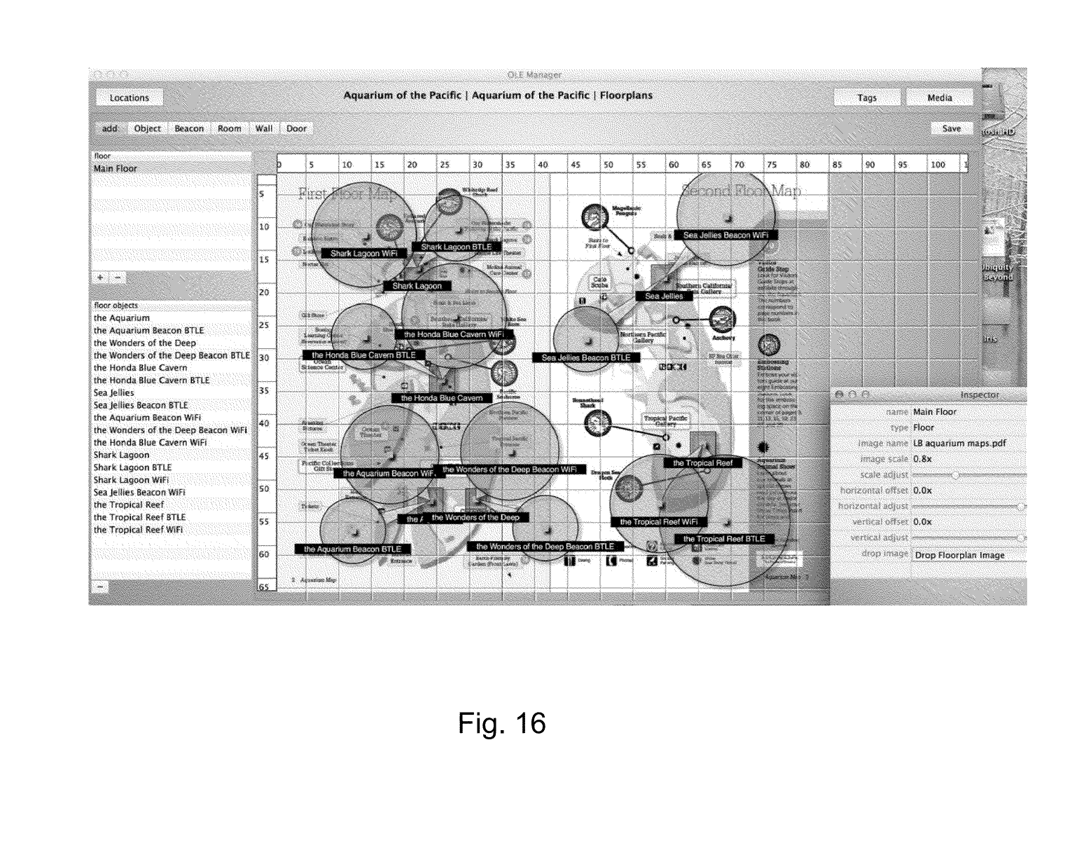

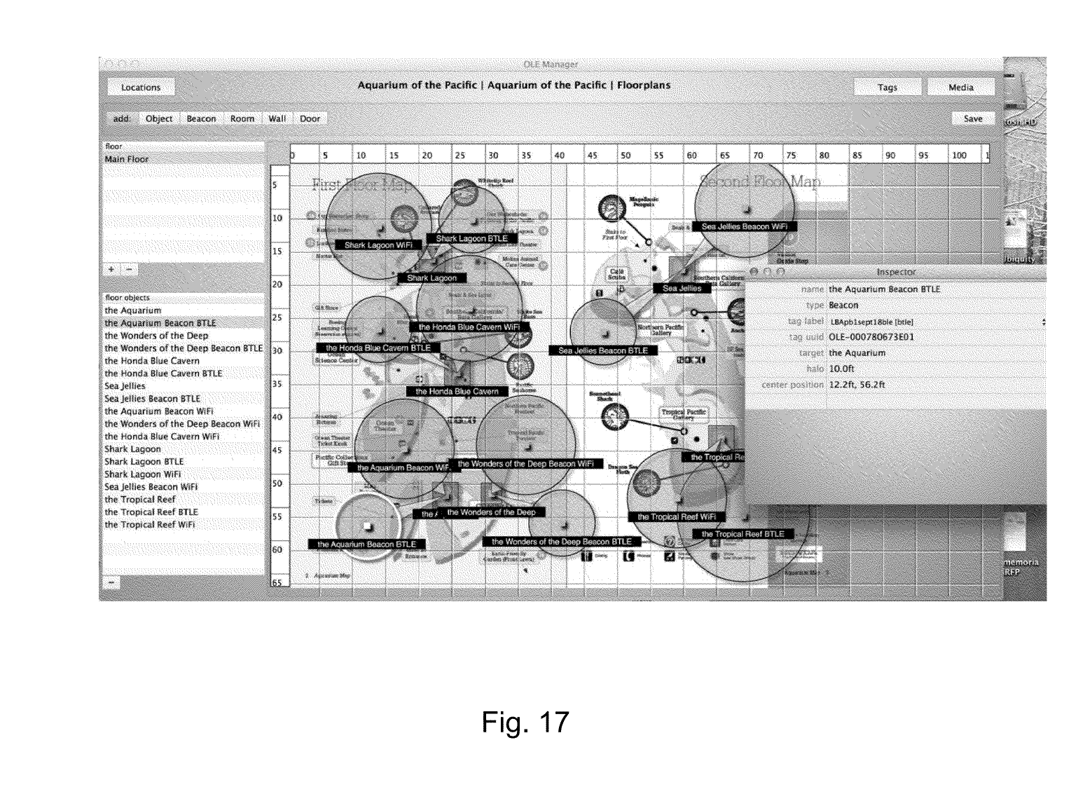

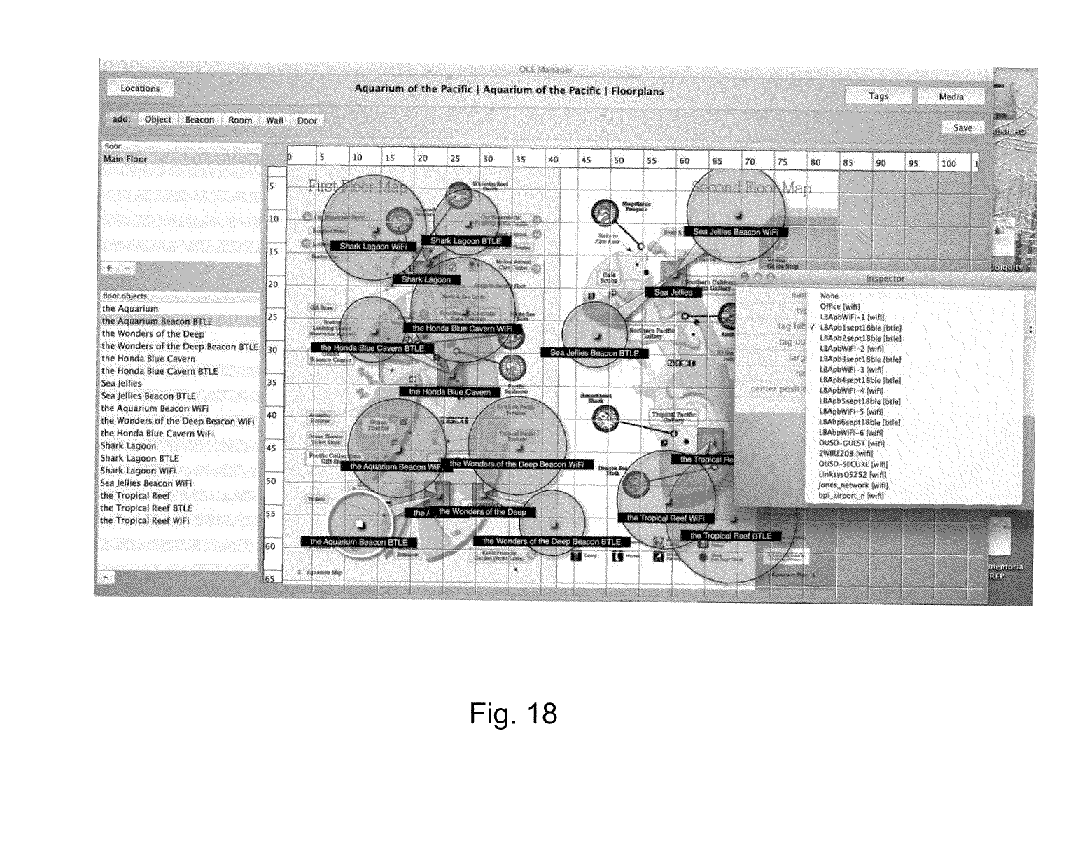

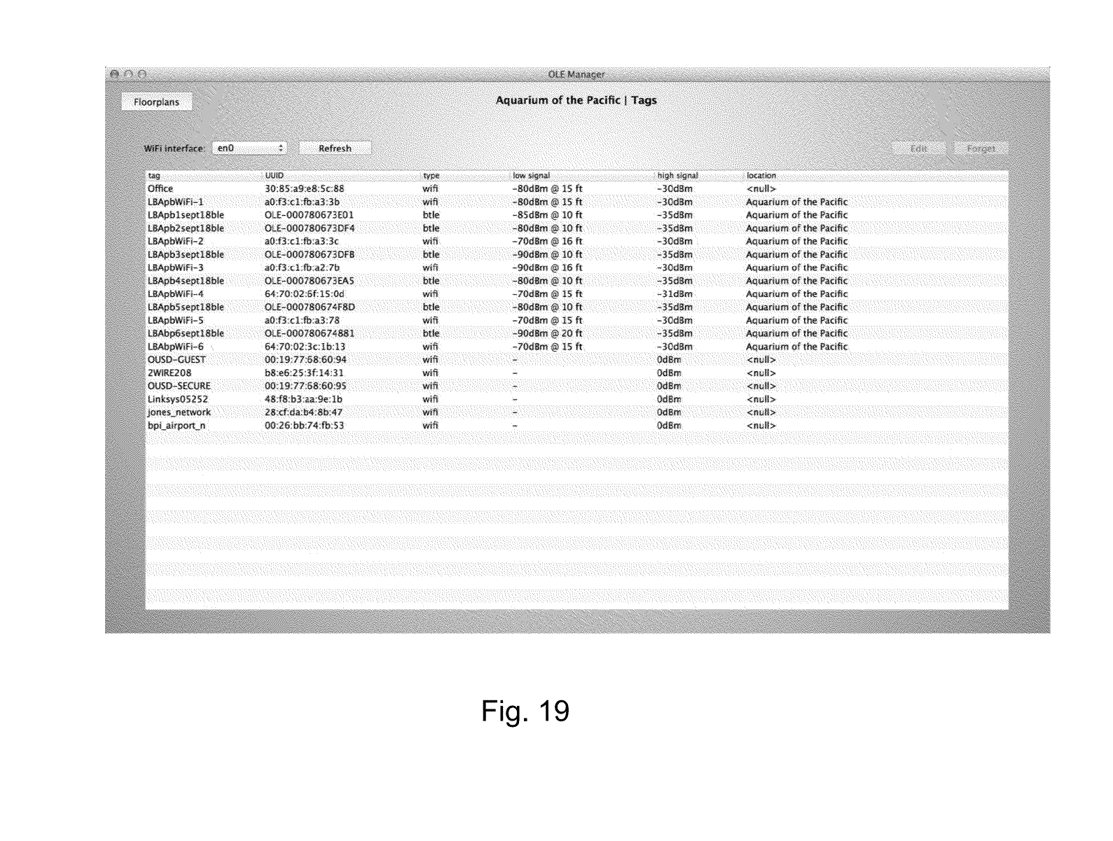

In FIG. 14, a map of client locations is depicted. The map may be a geographical map, as depicted in FIG. 14, and may, in some embodiments of the present invention, provide a search utility. Further views of the map may include a standard map view as depicted, a satellite view or a hybrid view of both satellite and standard views. Once a location is selected, a floor plan for that location may be selected. The floor plan, an example of which is provided by way of FIG. 15, contains the same functionality as described by way of FIG. 6, but an inspector function provides further details of the selected image. By selecting another client, and another location, another beacon floor plan layout is produced, as can be seen by way of FIG. 16. In FIG. 16, the inspector function provides details on the main floor layout being viewed. As can be seen in FIG. 17, by highlighting and selecting the Aquarium Beacon BTLE in the floor objects list to the right of FIG. 17, the inspector function provides further details on that selected beacon. Details such as the name of the beacon, the type of floor object, the tag label and tag uuid, the target of the beacon, the halo diameter of the beacon, and the coordinates of the center position of the beacon. By managing and providing this information with the inspector function, beacon placement can be optimized, providing an on location experience that has heretofore not been possible. FIG. 18 depicts the beacon floor plan layout used in previous examples where the inspector function has provided a list of available signals or networks in the floor plan. A listing of these signal sources is also provided in the OLE manager, an example of which can be seen in FIG. 19 where each signal source is listed with its tag, UUID, type, low and high signal strength, and location.

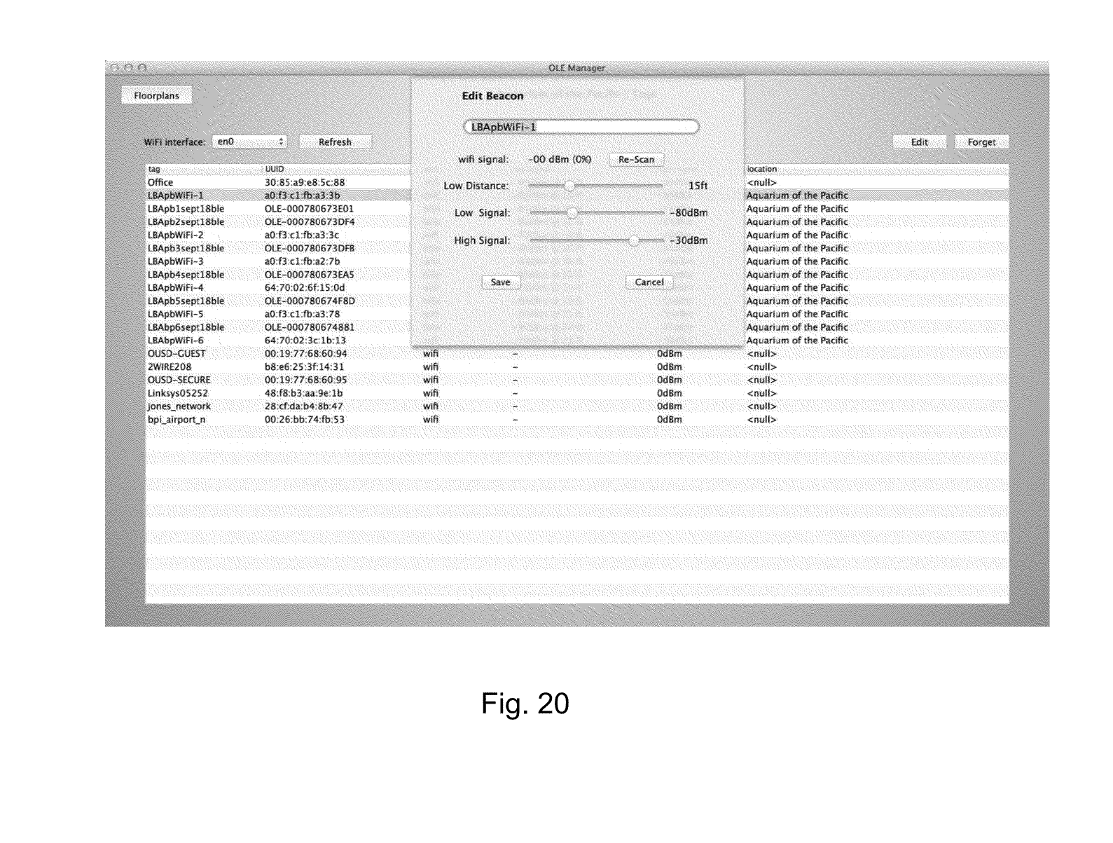

The OLE Manager also provides the ability to edit each beacon by controlling signal strength parameters such as low distance, low signal, and high signal, as depleted by way of FIG. 20.

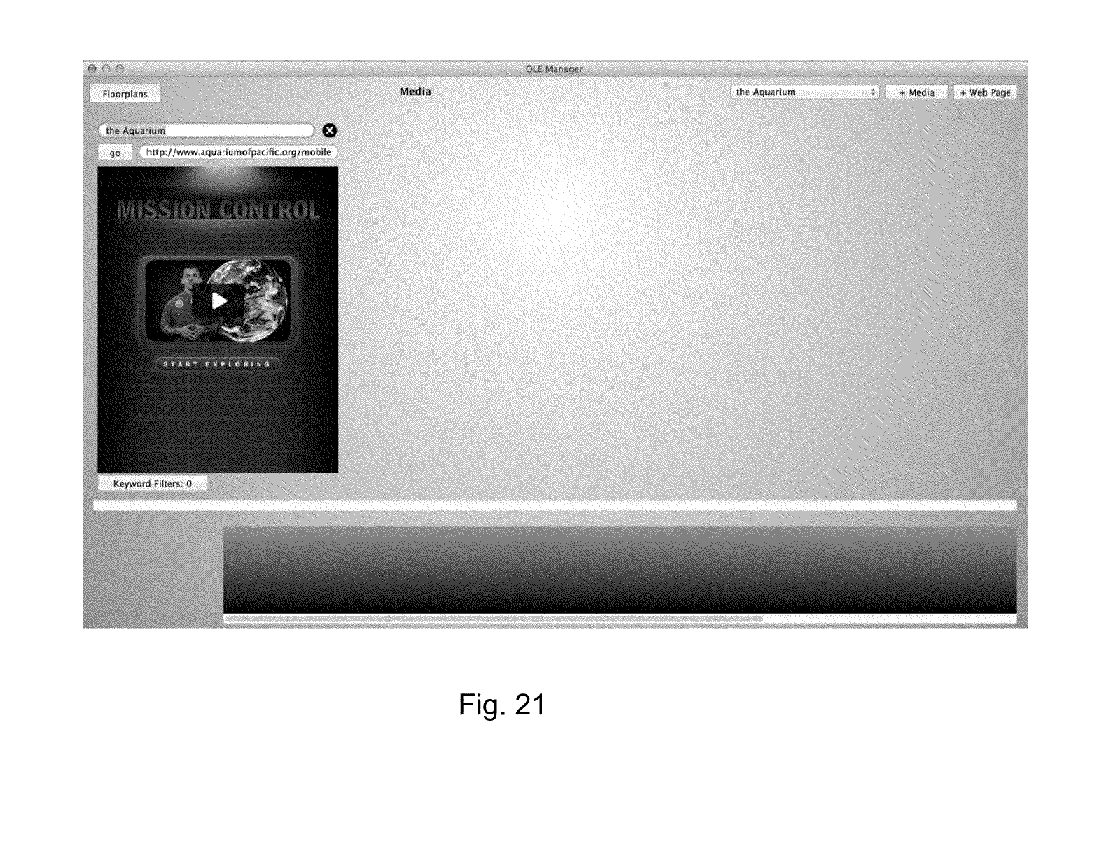

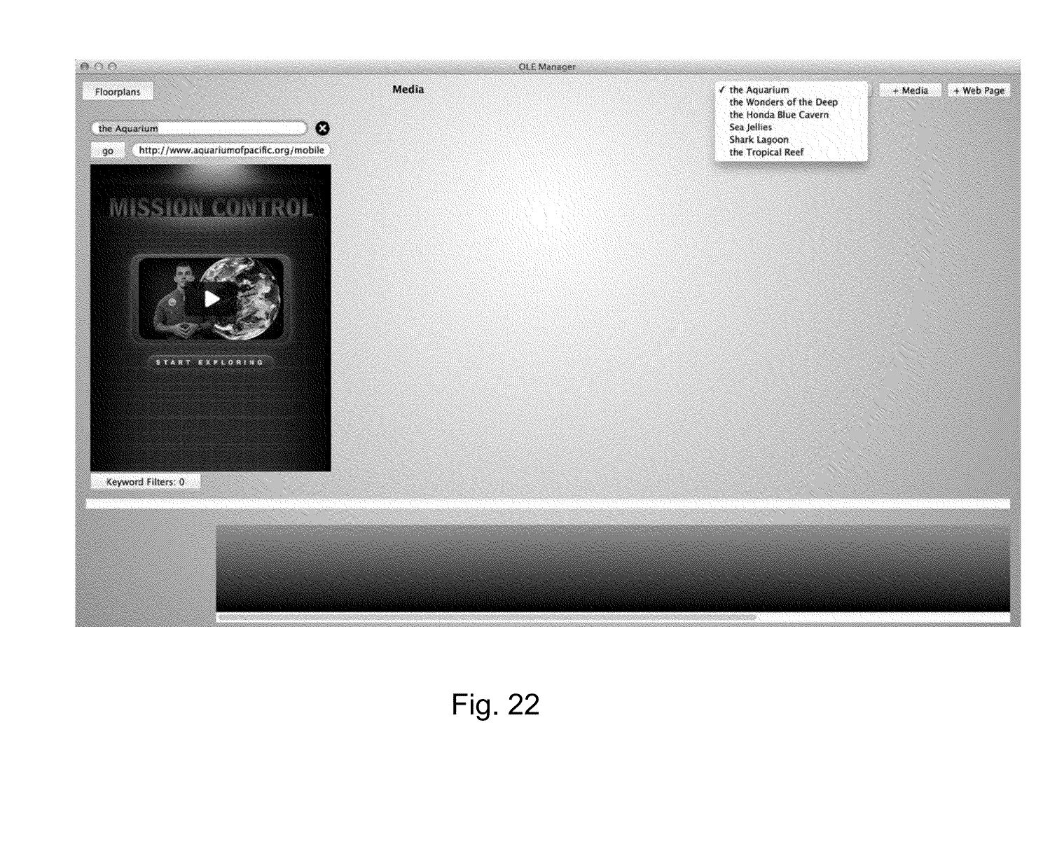

FIG. 21 depicts a main screen in the OLE manager where various locations within a floor plan can be explored. FIG. 22 shows where the various locations within the floor plan are selected through a drop down menu.

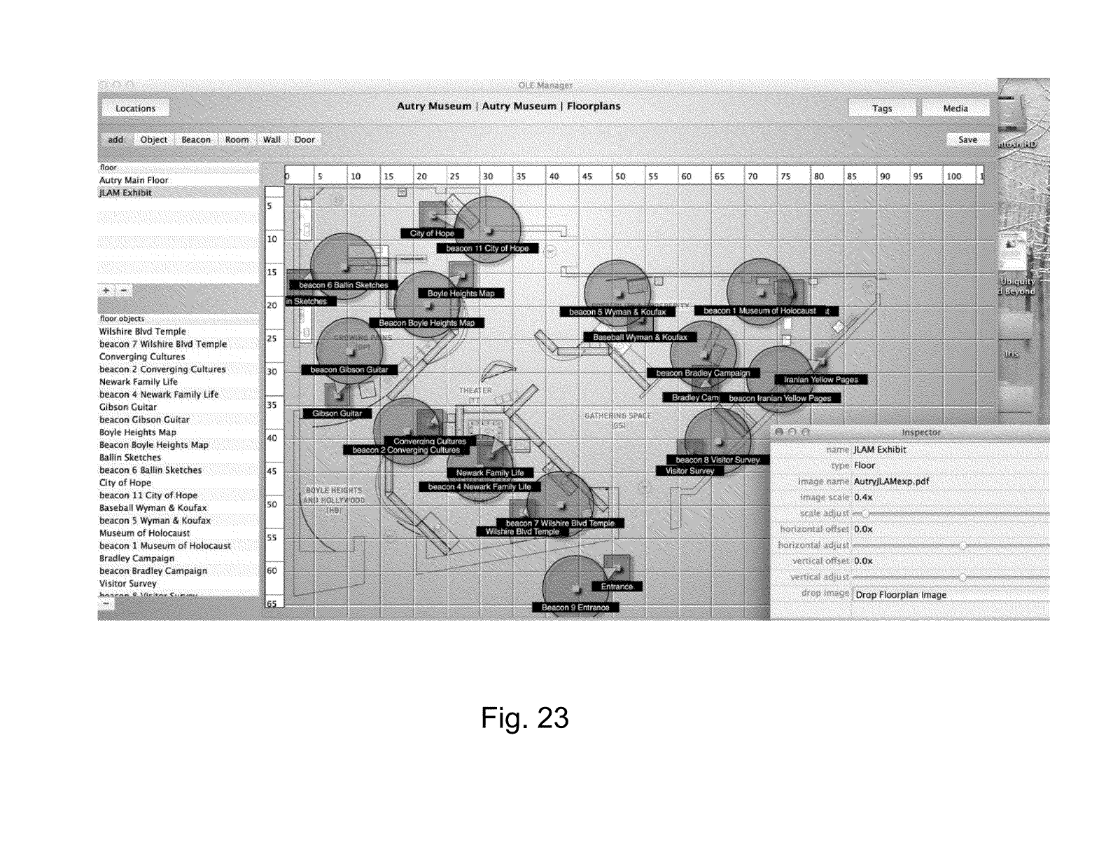

Now turning to FIG. 23, a beacon floor plan layout is again depicted where beacons and other floor objects are shown. As evident from FIG. 23, the beacon floor plan layout function provides utilities to add objects, beacons, rooms, walls, doors, and the like. This can be seen in the upper left of FIG. 23.

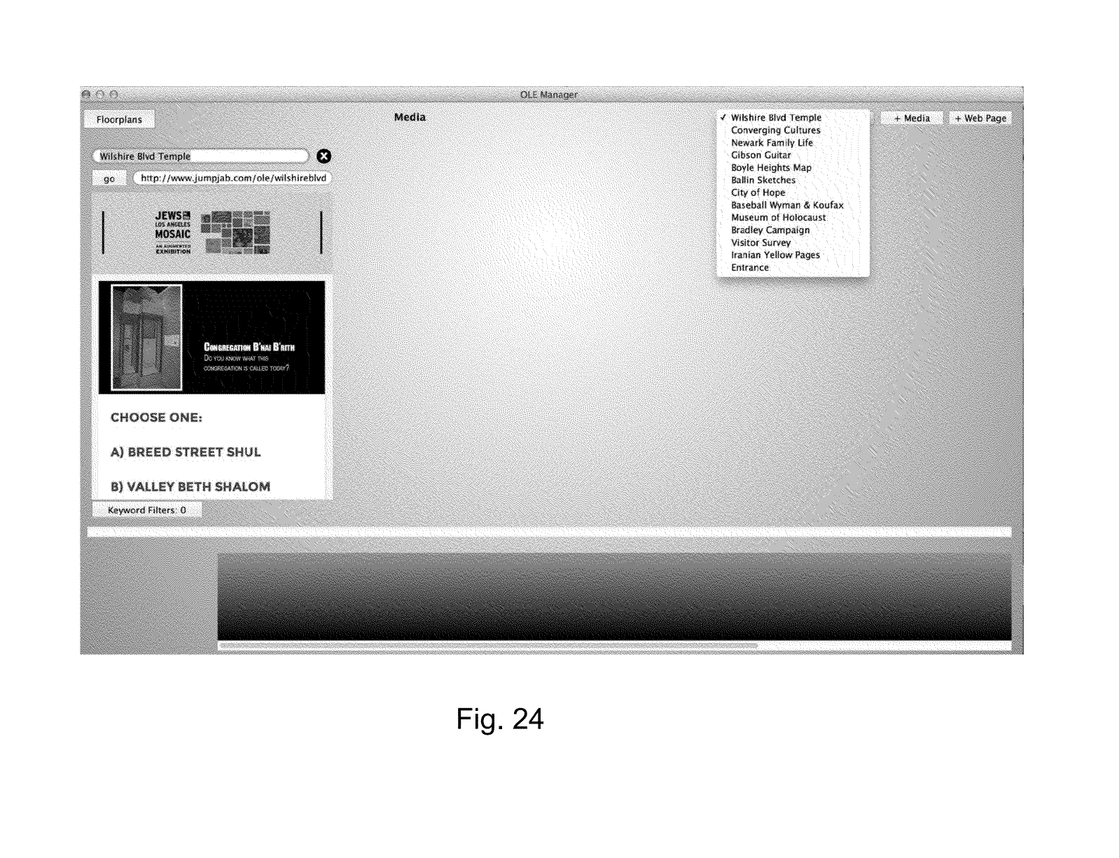

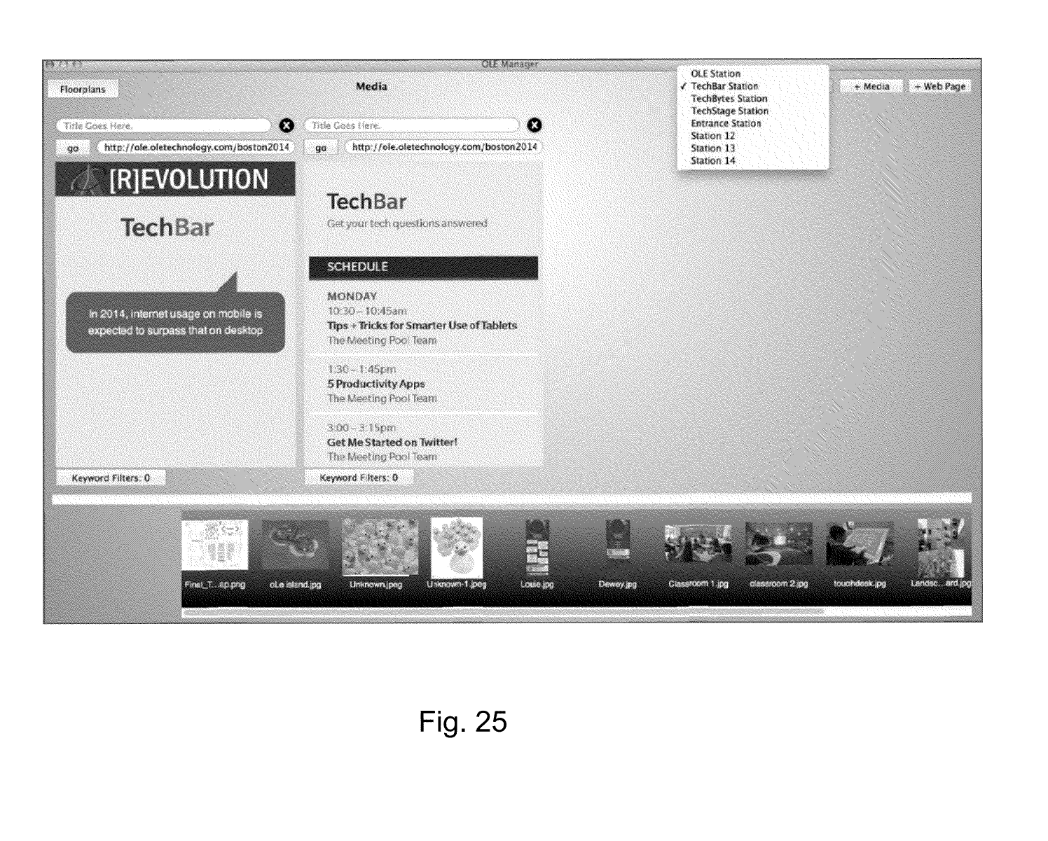

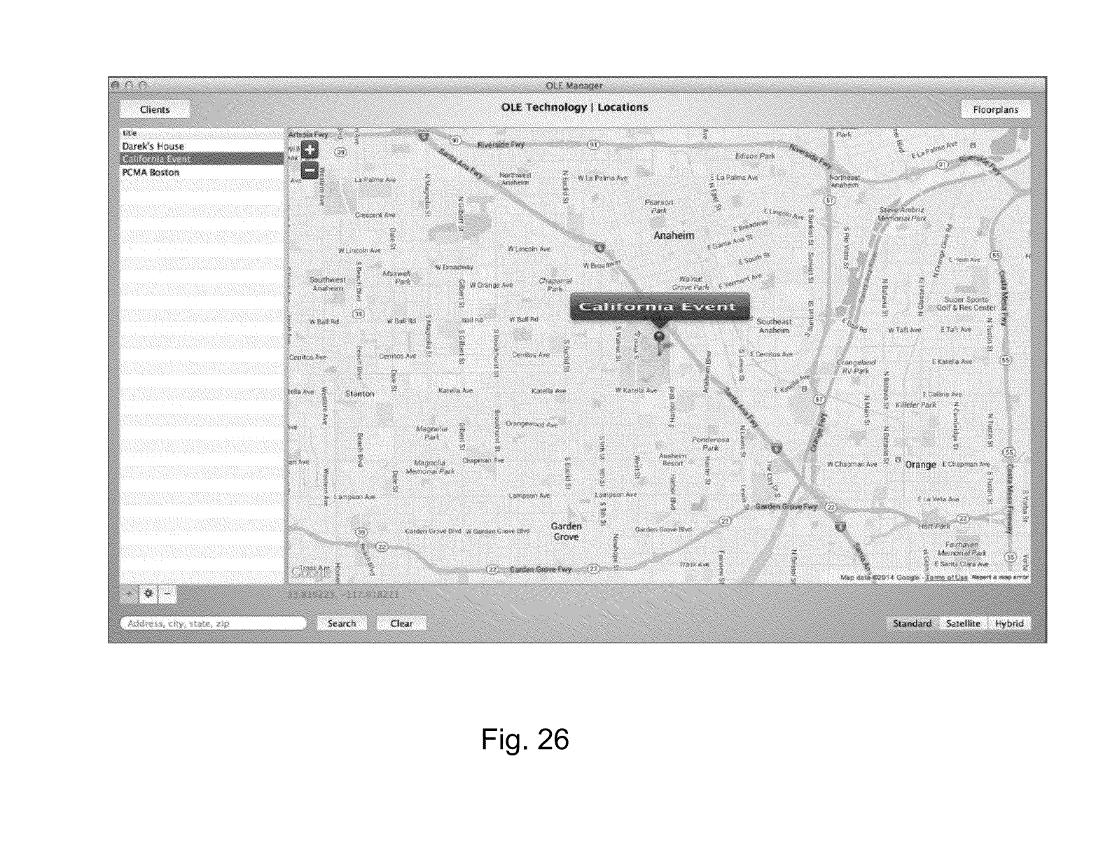

As seen in FIG. 24, when selecting a location, in some embodiments of the present invention a website can be associated with that location entry, providing such things as information, questions, images, and the like. In some embodiments of the present invention, the location entry can also be associated with information, such as a schedule of events or the like. FIG. 25 depicts such functionality where the location entry is associated with web based content or content from, another network or data source. In addition to floor plan location information and associated functionality and content, client locations can also be mapped as seen in FIG. 26.

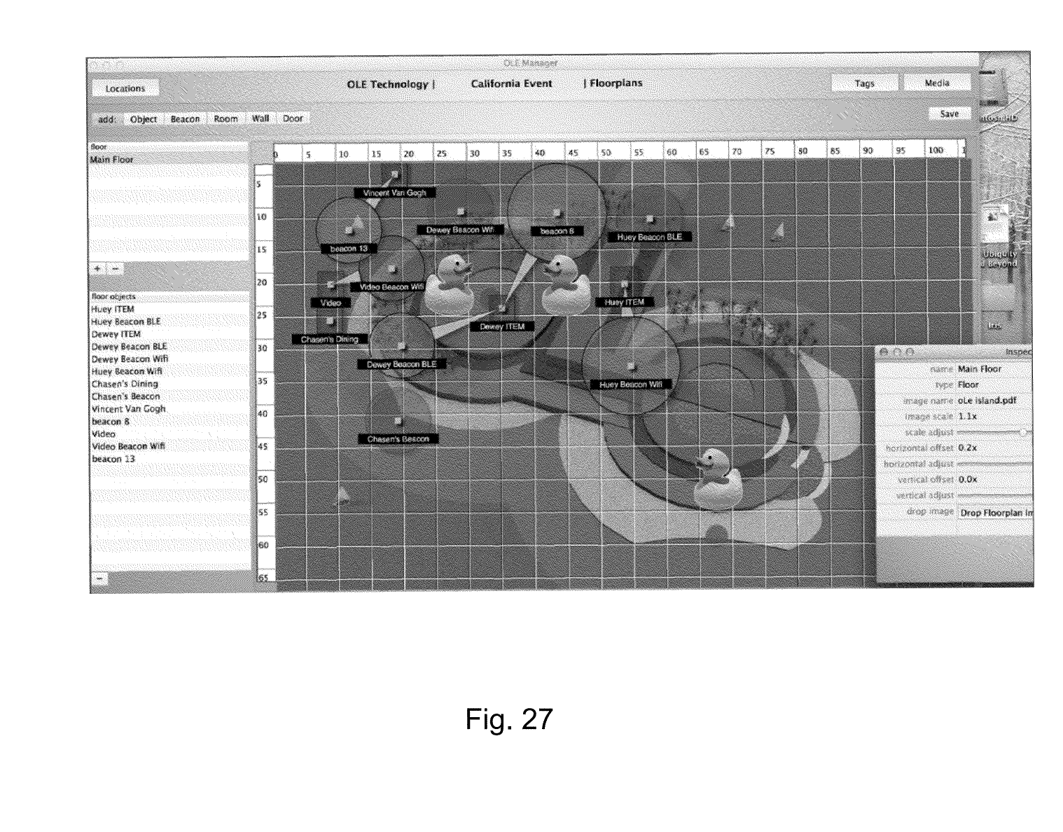

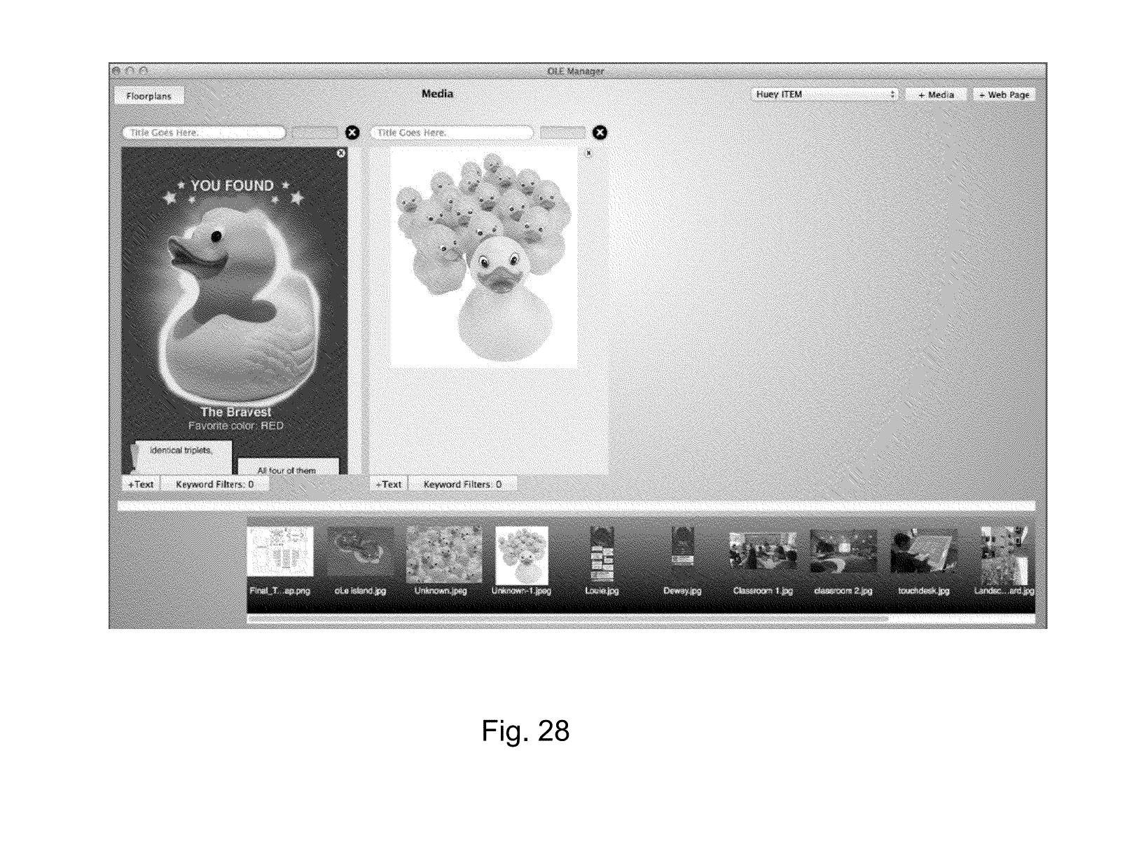

In some embodiments of the present invention, the beacon floor plan layout function may include images that are descriptive of the exhibit, the floor object, or the like. FIG. 27 depicts a beacon floor plan layout with images of clucks that are indicative of the displays on the beacon floor plan layout. As seen in FIG. 28, these images may be selected from a scrolling list of thumbnail images in the OLE manager and associated with a floor object or location on the floor plan.

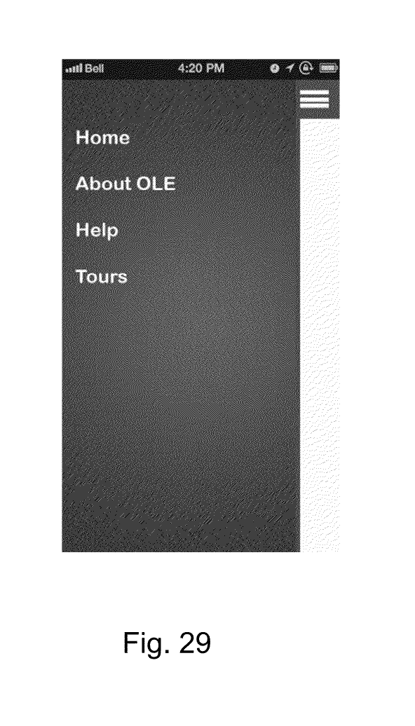

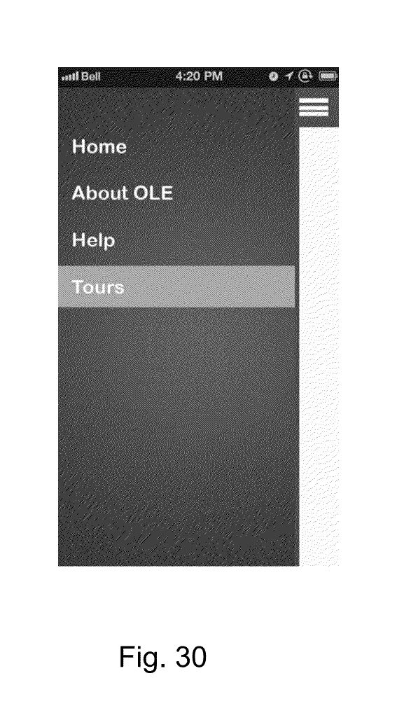

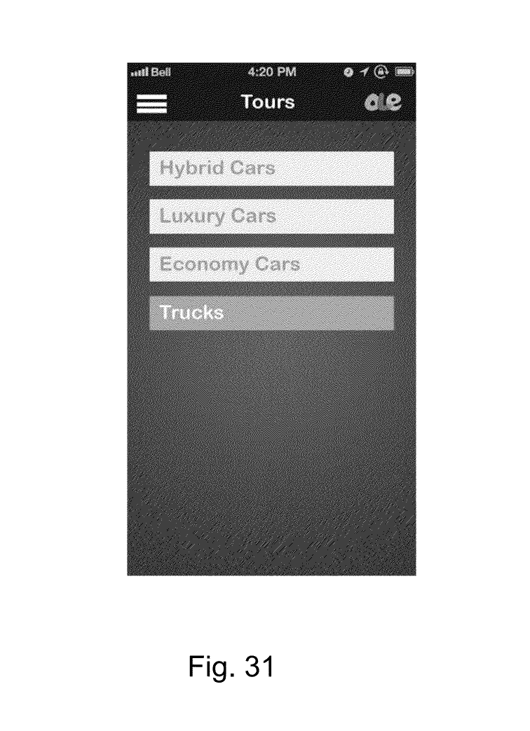

To provide several, working examples of screenshots for the OLE consumer app. FIGS. 29-31 depict examples of the tour functionality of the OLE consumer app. as seen on a handheld electronic device. FIG. 29 depicts an exemplary home screen for the OLE consumer app. In this example, FIG. 30 depicts the selection of the tours option at the home screen, and in turn FIG. 31 depicts various choices of tours presented to the user. In this example, the tours offered up are tours related to hybrid cars, luxury cars, economy cars, and trucks.

In some embodiments of the present invention, other graphical elements, components and visual representations may also be employed, and are considered within the spirit and broad scope of the present invention as described and envisioned herein.

It is, therefore, apparent that there has been provided, in accordance with the various objects of the present invention, a computer based system and method for content management and delivery of on location engagements

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims, and the attached drawings.

What is claimed is:

1. A system for content management and deliver of on location engagements comprising:
a computer having a processor, memory, and access to computer readable media;
a computer program stored on computer readable media having an OLE manager where the OLE manager comprises a beacon assignment/reassignment function, a beacon signal strength measurement function, a beacon signal strength adjustment function, and a content management function;
content stored on computer readable media for selective activation by the OLE manager;
at least one wireless beacon for location based delivery of an associated beacon identifier;
a means to correlate the beacon identifier with selected content; and
a consumer app resident on a wireless communications device that is capable of receiving and displaying the selected content.

2. The system of claim 1, wherein the content management function allows for the selection and filtering of location based content, user selected content, registration content, and owner based content.

3. The system of claim 1, wherein the OLE manager further comprises a user interface.

4. The system of claim 1, wherein the OLE manager further comprises a user information component stored on computer readable media.

5. The system of claim 1, wherein the user information component further comprises user input requests received on a computer.

6. The system of claim 1, wherein the user information component further comprises metadata from user registration datasources stored on computer readable media.

7. The system of claim 1, wherein the user information component further comprises historical user usage data stored on computer readable media.

8. The system of claim 1, further comprising an analytics module stored on computer readable media.

9. A computer based method for content management and filtering of content for on location engagements comprising the steps of:
establishing on a computer content to be delivered to a location;
detecting with a radiofrequency receiver a radiofrequency signal containing a beacon identifier;
measuring signal strength of the received radiofrequency signal;
comparing the measured signal strength of the received radiofrequency signal with measured signal strength of other received radiofrequency signals;
determining the location of a user based on the beacon identifier and the measured signal strength of the received radiofrequency signal;
selecting on a computer content based on a user's location;
modifying on a computer content to be delivered; and
filtering the modified content by user selection criteria on a wifeless communications device.

10. The computer based method of claim 9, further comprising the steps of:
receiving on a computer user registration information; and
filtering the selected content based on user registration information.

11. A beacon floor plan layout function stored on computer readable media and graphically displayed on a computer monitor comprising a graphically displayed floor plan of a venue, a map of radiofrequency beacons overlaid on the graphically displayed floor plan, and a circle circumscribing each mapped radiofrequency beacon where the diameter of each circumscribed circle corresponds to the signal strength of the radiofrequency beacon that the circle circumscribes.

12. The beacon floor plan layout function of claim 11, further comprising a map of floor stops overlaid on the graphically displayed floor plan indicative of the general location at which a visitor would stop to view a display.

13. The beacon floor plan layout function of claim 12, further comprising callouts from each circumscribed circle to the floor stop associated with the circumscribed circle.

14. The beacon floor plan layout function of claim 12, wherein a floor stop is associated with more than one beacon and more than one circumscribed circle.

15. The beacon floor plan layout function of claim 12, further comprising floor objects comprising radiofrequency beacons and floor stops.

16. The beacon floor plan layout function of claim 11, further comprising a measurement grid overlaid on the graphically displayed floor plan.

17. The beacon floor plan layout function of claim 11, further comprising a color associated with each circumscribed circle where the color is indicative of the status of each mapped radiofrequency beacon.

18. The beacon floor plan layout function of claim 17, wherein the color green is indicative of an active radiofrequency beacon.

19. The beacon floor plan layout function of claim 17, wherein the color red is indicative of an inactive radiofrequency beacon.

20. The beacon floor plan layout function of claim 11, wherein a mapped radiofrequency beacon without a circumscribed circle is indicative of a radiofrequency beacon that is not in operation.
